(19) United States
(12) Patent Application Publication
(10) Pub. No.: US 2024/0040590 A1
(43) Pub. Date: Feb. 1, 2024

(54) COMMUNICATION METHOD, APPARATUS, AND SYSTEM

(71) Applicant: HUAWEI TECHNOLOGIES CO., LTD., Shenzhen (CN)

(72) Inventors: Ruijie LI, Beijing (CN); Lei GUAN, Beijing (CN); Shengyu LI, Beijing (CN)

(21) Appl. No.: 18/477,122

(22) Filed: Sep. 28, 2023

Related U.S. Application Data
(63) Continuation of application No. PCT/CN2022/077332, filed on Feb. 22, 2022.

(30) Foreign Application Priority Data
Apr. 3, 2021 (CN) 202110364167.6

(51) Int. Cl. H04W 72/232; H04W 72/1273; H04L 5/00

(52) U.S. Cl. CPC H04W 72/232; H04W 72/1273; H04L 5/0055; H04L 5/0051

(57) ABSTRACT

A communication method, apparatus, and system are provided. A terminal device determines target DCI. The terminal device determines first information based on the target DCI, and sends the first information to a network device. The target DCI indicates a target PDSCH. The first information includes channel state information of the target PDSCH.

### CROSS-REFERENCE TO RELATED APPLICATIONS

This application is a continuation of International Application No. PCT/CN2022/077332, filed on Feb. 22, 2022, which claims priority to Chinese Patent Application No. 202110364167.6, filed on Apr. 3, 2021. The disclosures of the aforementioned application are hereby incorporated by reference in their entireties.

### BACKGROUND

Currently, a network device schedules data based on channel state information. However, in response to channel state information of a channel being inaccurate, the network device cannot effectively schedule data based on the channel state information. Consequently, reliability of data transmission is low.

### SUMMARY

Embodiments described herein provide a communication method, apparatus, and system, to resolve a problem of low reliability of data transmission in the conventional technology.

To achieve the foregoing objective, the following technical solutions are used in at least one embodiment.

According to a first aspect, embodiments described herein provide a communication method. An execution entity of the communication method is a terminal device, or is a chip in a terminal device, or is a unit or a module that is included in a terminal device and that performs the method. The method includes: The terminal device determines target downlink control information (downlink control information, DCI), determines first information based on the target DCI, and sends the first information to a network device. The target DCI indicates a target physical downlink shared channel (physical downlink shared channel, PDSCH), and the first information includes channel state information of the target PDSCH.

The terminal device determines one or more downlink transmissions based on the downlink control information, reports the channel state information to the network device based on the one or more downlink transmissions indicated by the downlink control information, and enables the network device to adjust, based on the channel state information reported by the terminal device, a parameter used for the data transmission. Therefore, reliability of the data transmission is improved by adjusting the parameter.

In at least one embodiment, the target PDSCH belongs to a first PDSCH set, the target DCI belongs to a first DCI set, and the first DCI set is associated with the first PDSCH set.

In at least one embodiment, the method for “the first DCI set is associated with the first PDSCH set” includes: Acknowledgment (acknowledgement, ACK) feedback information or negative acknowledgment (negative acknowledgment, NACK) feedback information corresponding to at least two PDSCHs in the first PDSCH set is located in one time unit. The ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by DCI in the first DCI set belongs to the first PDSCH set.

In at least one embodiment, the method for “the first DCI set is associated with the first PDSCH set” includes: A location of a time domain resource at which the ACK feedback information or the NACK feedback information corresponding to the at least two PDSCHs in the first PDSCH set is located is indicated through second DCI, and the second DCI belongs to the first DCI set.

In at least one embodiment, the second DCI is the target DCI.

In at least one embodiment, the target DCI indicates at least one of the following: the target PDSCH and a target cell, where the target cell is a cell in which the target PDSCH is located.

In at least one embodiment, the target DCI indicates the target PDSCH, and the target PDSCH is one or more PDSCHs in the first PDSCH set.

In at least one embodiment, the method for “the target DCI indicates the target PDSCH” includes: PDSCHs in the first PDSCH set are sorted according to a preset rule, where the target DCI indicates a location of the target PDSCH in the first PDSCH set.

In at least one embodiment, the target PDSCH is an N^{th} PDSCH that is obtained after the PDSCHs in the first PDSCH set are sorted according to the preset rule, and the N^{th} PDSCH is an N^{th} PDSCH in a positive order or in a reverse order.

In at least one embodiment, the target DCI is a last piece of DCI whose time domain is in ascending order in the first PDSCH set. Based on the foregoing manner, a PDSCH scheduled in the last piece of DCI is newer than a PDSCH scheduled in another piece of DCI in the first DCI set. Therefore, more timely channel state information is provided.

In at least one embodiment, the target DCI indicates the target cell, and the target PDSCH is one or more PDSCHs in the first PDSCH set that are located in the target cell.

In at least one embodiment, the method for “determining first information based on the target DCI” includes: The terminal device determines the first information based on data information included in the target PDSCH; or determines the first information based on a demodulation reference signal (demodulation reference signal, DMRS) corresponding to the target PDSCH.

In at least one embodiment, in response to the terminal device not receiving the target PDSCH, the first information includes first state information, and the first state information indicates that the target PDSCH is not received.

In at least one embodiment, the communication method further includes: The terminal device receives second information from the network device, where the second information is used to enable the terminal device to determine the first information based on the target DCI.

The terminal device enables determining of the first information only after receiving the second information. In response to the terminal device not receiving the second information, the terminal device does not need to receive or decode the first information. In response to the channel state information not being reported, energy consumption of the terminal device is reduced, and determining of the first information is also more flexible.

According to a second aspect, at least one embodiment provides a communication method. An execution entity of the communication method is a terminal device, or is a chip in a terminal device, or is a unit or a module that is included in a terminal device and that performs the method. The method includes: The terminal device determines target DCI, and determines, based on the target DCI, whether to report first information. The target DCI indicates whether the terminal device reports the first information. The first information includes channel state information of a target PDSCH.

The terminal device determines, based on the target DCI, whether to report the first information, and determines and reports the first information only in response to determining that the first information is to be reported. In response to determining that the first information not need being reported, the terminal device does not need to determine the first information. In response to the channel state information not being reported, energy consumption of the terminal device is reduced, and determining of the first information is also more flexible.

In at least one embodiment, the target PDSCH belongs to a first PDSCH set, the target DCI belongs to a first DCI set, and the first DCI set is associated with the first PDSCH set.

In at least one embodiment, the method for “the first DCI set is associated with the first PDSCH set” includes: Acknowledgment (acknowledgement, ACK) feedback information or negative acknowledgment (negative acknowledgment, NACK) feedback information corresponding to at least two PDSCHs in the first PDSCH set is located in one time unit. The ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by DCI in the first DCI set belongs to the first PDSCH set.

In at least one embodiment, the method for “the first DCI set is associated with the first PDSCH set” includes: A location of a time domain resource at which the ACK feedback information or the NACK feedback information corresponding to the at least two PDSCHs in the first PDSCH set is located is indicated through second DCI, and the second DCI belongs to the first DCI set.

In at least one embodiment, the second DCI is the target DCI.

In at least one embodiment, the target DCI indicates at least one of the following: the target PDSCH or a target cell, where the target cell is a cell in which the target PDSCH is located.

In at least one embodiment, the target DCI indicates the target PDSCH, and the target PDSCH is one or more PDSCHs in the first PDSCH set.

In at least one embodiment, the method for “the target DCI indicates the target PDSCH” includes: PDSCHs in the first PDSCH set are sorted according to a preset rule, where the target DCI indicates a location of the target PDSCH in the first PDSCH set.

In at least one embodiment, the target PDSCH is an N^{th} PDSCH that is obtained after the PDSCHs in the first PDSCH set are sorted according to the preset rule, and the N^{th} PDSCH is an N^{th} PDSCH in a positive order or in a reverse order.

In at least one embodiment, the target DCI is a last piece of DCI whose time domain is in ascending order in the first PDSCH set. Based on the foregoing manner, a PDSCH scheduled in the last piece of DCI is newer than a PDSCH scheduled in another piece of DCI in the first DCI set. Therefore, more timely channel state information is provided.

In at least one embodiment, the target DCI indicates the target cell, and the target PDSCH is one or more PDSCHs in the first PDSCH set that are located in the target cell.

In at least one embodiment, the method for “determining first information based on the target DCI” includes: The terminal device determines the first information based on data information included in the target PDSCH; or determines the first information based on a demodulation reference signal (demodulation reference signal, DMRS) corresponding to the target PDSCH.

In at least one embodiment, in response to the terminal device not receiving the target PDSCH, the first information includes first state information, and the first state information indicates that the target PDSCH is not received.

In at least one embodiment, the communication method further includes: The terminal device receives second information from the network device, where the second information is used to enable the terminal device to determine the first information based on the target DCI.

The terminal device enables determining of the first information only after receiving the second information. In response to the terminal device not receiving the second information, the terminal device does not need to receive or decode the first information. In response to the channel state information not being reported, energy consumption of the terminal device is reduced, and determining of the first information is also more flexible.

According to a third aspect, a communication method is provided. An execution entity of the communication method is a network device, or is a chip in a network device, or is a unit or a module that is included in a network device and that performs the method. The method includes: The network device sends target DCI to a terminal device, where the target DCI indicates a PDSCH; and the network device receives first information from the terminal device, where the first information is determined based on the target DCI, and the first information includes channel state information of a target PDSCH.

The network device receives channel state information reported by the terminal device, and adjust, based on the channel state information, a parameter used for data transmission. Because the channel state information is obtained by determining, by the terminal device, one or more downlink transmissions based on downlink control information, and is determined based on one or more downlink transmissions indicated by the downlink control information, reliability of the data transmission is improved by adjusting the parameter.

In at least one embodiment, the method for “the first DCI set is associated with the first PDSCH set” includes: ACK feedback information or NACK feedback information corresponding to at least two PDSCHs in the first PDSCH set is located in one time unit. The ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by DCI in the first DCI set belongs to the first PDSCH set.

In at least one embodiment, the method for “the first DCI set is associated with the first PDSCH set” includes: A location of a time domain resource at which the ACK feedback information or the NACK feedback information corresponding to the at least two PDSCHs in the first PDSCH set is located is indicated through second DCI, and the second DCI belongs to the first DCI set.

In at least one embodiment, the second DCI is the target DCI.

In at least one embodiment, the target DCI indicates at least one of the following: the target PDSCH or a target cell, where the target cell is a cell in which the target PDSCH is located.

In at least one embodiment, the target DCI indicates the target PDSCH, and the target PDSCH is one or more PDSCHs in the first PDSCH set.

In at least one embodiment, the method for “the target DCI indicates the target PDSCH” includes: PDSCHs in the first PDSCH set are sorted according to a preset rule, where the target DCI indicates a location of the target PDSCH in the first PDSCH set.

In at least one embodiment, the target PDSCH is an N^{th} PDSCH that is obtained after the PDSCHs in the first PDSCH set are sorted according to the preset rule, and the N^{th} PDSCH is an N^{th} PDSCH in a positive order or in a reverse order.

In at least one embodiment, the target DCI is a last piece of DCI whose time domain is in ascending order in the first PDSCH set. Based on the foregoing manner, a PDSCH scheduled in the last piece of DCI is newer than a PDSCH scheduled in another piece of DCI in the first DCI set. Therefore, more timely channel state information is provided.

In at least one embodiment, the target DCI indicates the target cell, and the target PDSCH is one or more PDSCHs in the first PDSCH set that are located in the target cell.

In at least one embodiment, the communication method further includes: The network device sends second information to the terminal device, where the second information is used to enable the terminal device to determine the first information based on the target DCI.

According to a fourth aspect, a communication method is provided. An execution entity of the communication method is a network device, or is a chip in a network device, or is a unit or a module that is included in a network device and that performs the method. The method includes: The network device sends target DCI to a terminal device, where the target DCI indicates whether the terminal device reports first information, and the target DCI indicates a target PDSCH, the network device receives the first information from the terminal device, where the first information is determined based on the target DCI, and the first information includes channel state information of the target PDSCH.

The target DCI indicates whether the terminal device reports the first information. The terminal device determines and reports the first information only in response to determining that the first information is to be reported, and the network device receives the first information. In response to determining that the first information is not to be reported, the terminal device does not need to determine the first information. In response to the channel state information not being reported, energy consumption of the terminal device is reduced, and determining of the first information is also more flexible.

In at least one embodiment, the target PDSCH belongs to a first PDSCH set, the target DCI belongs to a first DCI set, and the first DCI set is associated with the first PDSCH set.

In at least one embodiment, the method for “the first DCI set is associated with the first PDSCH set” includes: ACK feedback information or NACK feedback information corresponding to at least two PDSCHs in the first PDSCH set is located in one time unit. The ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by DCI in the first DCI set belongs to the first PDSCH set.

In at least one embodiment, the method for “the first DCI set is associated with the first PDSCH set” includes: A location of a time domain resource at which the ACK feedback information or the NACK feedback information corresponding to the at least two PDSCHs in the first PDSCH set is located is indicated through second DCI, and the second DCI belongs to the first DCI set.

In at least one embodiment, the second DCI is the target DCI.

In at least one embodiment, the target DCI indicates at least one of the following: the target PDSCH or a target cell, where the target cell is a cell in which the target PDSCH is located.

In at least one embodiment, the target DCI indicates the target PDSCH, and the target PDSCH is one or more PDSCHs in the first PDSCH set.

In at least one embodiment, the method for “the target DCI indicates the target PDSCH” includes: The target DCI indicates a location of the target PDSCH in the first PDSCH set, and the PDSCHs in the first PDSCH set are sorted according to a preset rule.

In at least one embodiment, the target PDSCH is an N^{th} PDSCH that is obtained after the PDSCHs in the first PDSCH set are sorted according to the preset rule, and the N^{th} PDSCH is an N^{th} PDSCH in a positive order or in a reverse order.

In at least one embodiment, the target DCI is a last piece of DCI whose time domain is in ascending order in the first PDSCH set. Based on the foregoing manner, a PDSCH scheduled in the last piece of DCI is newer than a PDSCH scheduled in another piece of DCI in the first DCI set. Therefore, more timely channel state information is provided.

In at least one embodiment, the target DCI indicates the target cell, and the target PDSCH is one or more PDSCHs in the first PDSCH set that are located in the target cell.

In at least one embodiment, the communication method further includes: sending second information to the terminal device, where the second information is used to enable the terminal device to determine the first information based on the target DCI.

According to a fifth aspect, at least one embodiment provides a communication apparatus. The communication apparatus includes at least one module configured to perform the communication method according to the first aspect or any implementation of the first aspect. Alternatively, the communication apparatus includes at least one module configured to perform the communication method according to the second aspect or any implementation of the second aspect.

According to a sixth aspect, at least one embodiment provides a communication apparatus. The communication apparatus includes at least one module configured to perform the communication method according to the third aspect or any implementation of the third aspect. Alternatively, the communication apparatus includes at least one module configured to perform the communication method according to the fourth aspect or any implementation of the fourth aspect.

According to a seventh aspect, at least one embodiment provides a communication apparatus. The communication apparatus includes a memory and a processor. The memory is coupled to the processor. The memory is configured to store computer program code, and the computer program code includes computer instructions. In response to the processor executing the computer instructions, the communication apparatus performs the communication method according to the first aspect or any implementation of the first aspect, or performs the communication method according to the second aspect or any implementation of the second aspect.

According to an eighth aspect, at least one embodiment provides a communication apparatus. The communication apparatus includes a memory and a processor. The memory is coupled to the processor. The memory is configured to store computer program code, and the computer program code includes computer instructions. In response to the processor executing the computer instructions, the communication apparatus performs the communication method according to the third aspect or any implementation of the third aspect, or performs the communication method according to the fourth aspect or any implementation of the fourth aspect.

According to a ninth aspect, at least one embodiment provides a chip system. The chip system is applied to a communication apparatus. The chip system includes one or more interface circuits and one or more processors. The interface circuit and the processor are connected to each other through a line; and the interface circuit is configured to receive a signal from a memory of the communication apparatus, and send the signal to the processor. The signal includes computer instructions stored in the memory. In response to the processor executes the computer instructions, the communication apparatus performs the communication method according to the first aspect or any implementation of the first aspect, or performs the communication method according to the second aspect or any implementation of the second aspect.

According to a tenth aspect, at least one embodiment provides a chip system. The chip system is applied to a communication apparatus. The chip system includes one or more interface circuits and one or more processors. The interface circuit and the processor are connected to each other through a line; and the interface circuit is configured to receive a signal from a memory of the communication apparatus, and send the signal to the processor. The signal includes computer instructions stored in the memory. In response to the processor executing the computer instructions, the communication apparatus performs the communication method according to the third aspect or any implementation of the third aspect, or performs the communication method according to the fourth aspect or any implementation of the fourth aspect.

According to an eleventh aspect, at least one embodiment provides a computer-readable storage medium. The computer-readable storage medium includes computer instructions. In response to the computer instructions are run on a communication apparatus, the communication apparatus is enabled to perform the communication method according to the first aspect and any implementation of the first aspect, or perform the communication method according to the second aspect and any implementation of the second aspect.

According to a twelfth aspect, at least one embodiment provides a computer-readable storage medium. The computer-readable storage medium includes computer instructions. In response to the computer instructions running on a communication apparatus, the communication apparatus is enabled to perform the communication method according to the third aspect or any implementation of the third aspect, or perform the communication method according to the fourth aspect or any implementation of the fourth aspect.

According to a thirteenth aspect, at least one embodiment provides a computer program product. The computer program product includes computer instructions. In response to the computer instructions running on a communication apparatus, the communication apparatus is enabled to perform the communication method according to the first aspect or any implementation of the first aspect, or perform the communication method according to the second aspect or any implementation of the second aspect.

According to a fourteenth aspect, at least one embodiment provides a computer program product. The computer program product includes computer instructions. In response to the computer instructions running on a communication apparatus, the communication apparatus is enabled to perform the communication method according to the third aspect or any implementation of the third aspect, or perform the communication method according to the fourth aspect or any implementation of the fourth aspect.

According to a fifteenth aspect, at least one embodiment provides a communication system, including at least one network device and at least one terminal device. In response to the network device and the terminal device are in the communication system, the network device and the terminal device are configured to perform the method according to any one of the first aspect to the fourth aspect or any manner of the foregoing aspect.

These aspects or other aspects of embodiments described herein are simpler and easier to understand in the following description.

### BRIEF DESCRIPTION OF DRAWINGS

FIG. 1 is a schematic diagram of a structure of a communication system according to at least one embodiment;

FIG. 2 is a schematic diagram of indicating a time unit through K1 according to at least one embodiment;

FIG. 3a is a schematic diagram of a scenario in which a terminal device determines a time unit according to at least one embodiment;

FIG. 3b is a schematic diagram of a PUCCH resource set according to at least one embodiment;

FIG. 3c is a schematic diagram of feeding back a CQI by a terminal device according to at least one embodiment;

FIG. 3d is a schematic diagram of reporting types of three channel states according to at least one embodiment;

FIG. 4 is a schematic diagram of a structure of a communication apparatus according to at least one embodiment;

FIG. 5 is a schematic flowchart 1 of a communication method according to at least one embodiment;

FIG. 6 is a schematic diagram of feeding back a plurality of ACKs/NACKs in one slot according to at least one embodiment;

FIG. 7 is a schematic diagram 1 of a first PDSCH set according to at least one embodiment;

FIG. 8 is a schematic diagram 2 of a first PDSCH set according to at least one embodiment;

FIG. 9 is a schematic diagram 1 of a scenario in which a terminal device determines target DCI according to at least one embodiment;

FIG. 10 is a schematic diagram 2 of a scenario in which a terminal device determines target DCI according to at least one embodiment;

FIG. 11a is a schematic diagram 3 of a scenario in which a terminal device determines target DCI according to at least one embodiment;

FIG. 11b is a schematic diagram 4 of a scenario in which a terminal device determines target DCI according to at least one embodiment;

FIG. 12a is a schematic diagram 1 of a target PDSCH according to at least one embodiment;

FIG. 12b is a schematic diagram 2 of a target PDSCH according to at least one embodiment;

FIG. 13 is a schematic flowchart 2 of a communication method according to at least one embodiment;

FIG. 14 is a schematic diagram 1 of a structure of a communication apparatus according to at least one embodiment;

FIG. 15 is a schematic diagram 2 of a structure of a communication apparatus according to at least one embodiment;

FIG. 16 is a schematic diagram 3 of a structure of a communication apparatus according to at least one embodiment;

FIG. 17 is a schematic diagram 4 of a structure of a communication apparatus according to at least one embodiment;

FIG. 18 is a schematic diagram 5 of a structure of a communication apparatus according to at least one embodiment; and

FIG. 19 is a schematic diagram 6 of a structure of a communication apparatus according to at least one embodiment.

### DESCRIPTION OF EMBODIMENTS

In embodiments described herein, the word “exemplary” or “for example” is used to represent giving an example, an illustration, or a description. Any embodiment or design scheme described as an “exemplary” or “for example” in embodiments described herein should not be explained as being more preferred or having more advantages than another embodiment or design scheme. Exactly, use of the word “example”, “for example”, or the like is intended to present a related concept in a specific manner.

The following terms “first” and “second” are merely intended for a purpose of description, and shall not be understood as an indication or implication of relative importance or implicit indication of a quantity of indicated technical features. Therefore, a feature limited by “first” or “second” explicitly or implicitly includes one or more features. In the descriptions of embodiments herein, unless otherwise stated, “a plurality of” means two or more than two.

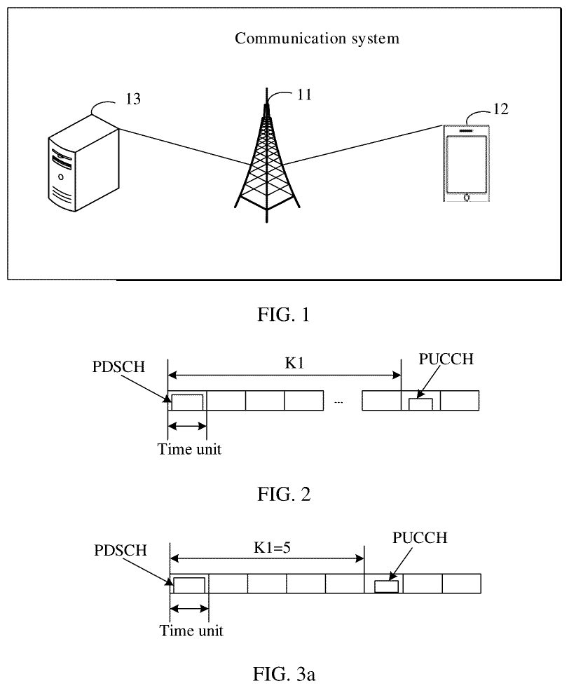

The communication method provided in embodiments described herein is applicable to a communication system. FIG. 1 shows a structure of the communication system. As shown in FIG. 1, the communication system includes: at least one access network device 11 and at least one terminal device 12. The access network device 11 and the terminal device 12 establish a connection in a wireless communication manner or a wired communication manner.

For example, uplink transmission means that the terminal device 12 sends uplink information to the access network device 11. The uplink information includes one or more of uplink data information, uplink control information, and a reference signal (reference signal, RS). A channel used to transmit the uplink information is referred to as an uplink channel, and the uplink channel is a physical uplink shared channel (physical uplink shared channel, PUSCH) or a physical uplink control channel (physical uplink control channel, PUCCH). The PUSCH is used to carry uplink data, and the uplink data is also referred to as the uplink data information. The PUCCH is used to carry uplink control information (uplink control information, UCI) fed back by the terminal device. The UCI includes channel state information (channel state information, CSI), an ACK/NACK, and the like.

For example, downlink transmission means that the access network device 11 sends downlink information to the terminal device 12. The downlink information includes one or more of downlink data information, downlink control information, and a downlink reference signal. The downlink reference signal is a channel state information reference signal (channel state information reference signal, CSI-RS) or a phase tracking reference signal (phase tracking reference signal, PTRS). A channel used to transmit the downlink information is referred to as a downlink channel, and the downlink channel is a PDSCH or a physical downlink control channel (physical downlink control channel, PDCCH). The PDCCH is used to carry DCI, and the PDSCH is used to carry downlink data. The downlink data is also referred to as the downlink data information.

Optionally, a network architecture shown in FIG. 1 further includes a core network device 13. The terminal device 12 is connected to the access network device 11 in a wireless manner, and the access network device 11 is connected to the core network device 13 in a wired or wireless manner. The core network device 13 and the access network device 11 is independent different physical devices, or the core network device 13 and the access network device 11 is a same physical device, and all/a part of logical functions of the core network device 13 and the access network device 11 are integrated into the physical device.

In the network architecture shown in FIG. 1, the terminal device 12 is fixed, or is movable. This is not limited. The network architecture shown in FIG. 1 further includes another network device, such as a wireless relay device and a wireless backhaul device. This is not limited. In the architecture shown in FIG. 1, a quantity of terminal devices, a quantity of access network devices, and a quantity of core network devices are not limited.

The technical solutions in at least one embodiment is applied to various communication systems. For example, a long term evolution (long term evolution, LTE) system, a 5th generation (5th generation, 5G) mobile communication system, and a future mobile communication system.

Based on the network architecture provided in FIG. 1, the following describes dynamic scheduling and semi-persistent scheduling.

The access network device sends the downlink control information to the terminal device in dynamic scheduling. The terminal device receives, on the PDCCH, the downlink control information sent by the access network device. After receiving the downlink control information, the terminal device receives downlink data carried on the PDSCH indicated by the downlink control information, and decode the received downlink data. In response to the terminal device successfully decoding the downlink data, the terminal device sends ACK feedback information to the network device. In response to the terminal device failing to decode the downlink data, the terminal device sends NACK feedback information to the network device.

The access network device sends higher layer signaling (for example, the higher layer signaling is RRC control signaling) to the terminal device in semi-persistent scheduling. After receiving the higher layer signaling, in response to the terminal device further receiving the activated downlink control information, the terminal device receives, based on indication information in the activated downlink control information and a configuration of the higher layer signaling, the downlink data that is carried on the PDSCH and that is sent by the network device. After receiving the downlink data, the terminal device decodes the downlink data, and send the ACK feedback information or the NACK feedback information to the network device. A difference between the semi-persistent scheduling and the dynamic scheduling lies in that, after being activated through the downlink control information, indication and scheduling of the downlink control information are no longer used in a subsequent downlink data transmission process. In a case of the dynamic scheduling or semi-persistent scheduling, before sending, to the access network device, the ACK feedback information or the NACK feedback information corresponding to the PDSCH, the terminal device needs to first determine a resource used for feeding back the ACK feedback information or the NACK feedback information, and then, send the ACK feedback information or the NACK feedback information by using the determined resource.

A resource of the ACK feedback information or the NACK feedback information corresponding to the PDSCH is indicated by the network device. For example, the network device first indicates a first time unit to the terminal device through K1. Then, in the first time unit, the terminal device determines, with reference to factors such as indication information sent by the network device and a payload size (payload size), a PUCCH resource used for sending the ACK feedback information or the NACK feedback information in the first time unit. The indication information is a PUCCH resource indicator (PUCCH resource indicator, PRI). The payload size refers to a size of information to be sent on the PUCCH resource. For example, the payload size is 5 bits (bit).

FIG. 2 is a schematic diagram of indicating a first time unit through K1. As shown in FIG. 2, K1 represents an interval between a time unit in which a PDSCH is located and a time unit in which a PUCCH is located. Specifically, a start point of K1 is a time unit in which a terminal device receives the PDSCH, and an end point of K1 is a first time unit in which ACK feedback information or NACK feedback information corresponding to the PDSCH is fed back.

In some embodiments, in a case of dynamic scheduling, indication information of K1 and indication information used to determine a PUCCH resource is carried in DCI. In a case of semi-persistent scheduling, the indication information of K1 and the indication information used to determine the PUCCH resource is configured through higher layer signaling, or is determined through DCI used to activate the semi-persistent scheduling.

A specific implementation of K1 is as follows: The network device preconfigures a set of K1 for the terminal device. In this way, the terminal device determines one value from the set through the indication information of K1, and determine, based on the value, a first time unit used to feed back an ACK or a NACK corresponding to the PDSCH.

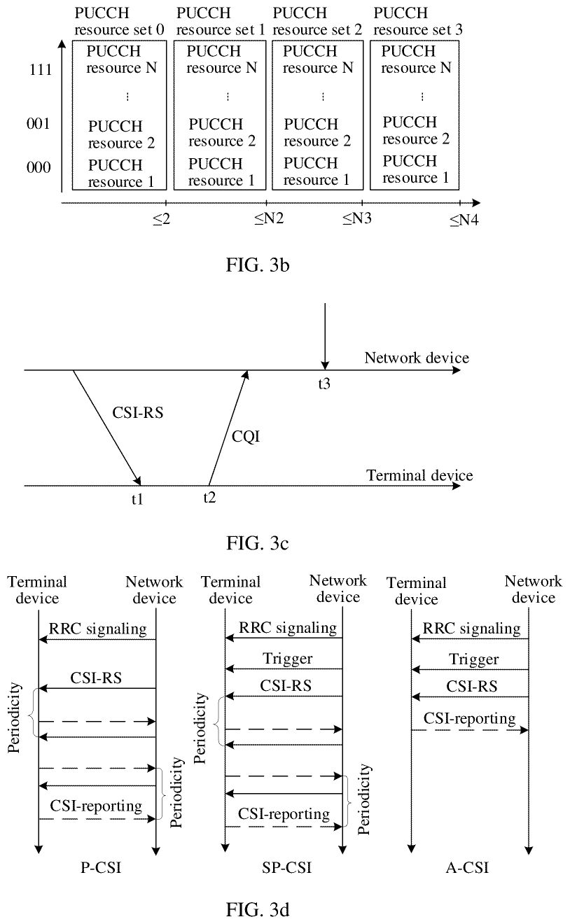

For example, with reference to FIG. 2, an assumption is that the set of K1 configured by the network device for the terminal device is {1, 2, 3, 4, 5}, and the terminal device determines that K1=5 through the indication information of K1. In this case, as shown in FIG. 3a, the terminal device determines that the first time unit is a fifth time unit after the PDSCH is received.

After determining the first time unit for feeding back the ACK/NACK, the terminal device determines, in the first time unit, the PUCCH resource used to send the ACK feedback information or the NACK feedback information.

Feedback of the ACK/NACK supports feedback in a form of a codebook. The codebook is a string of sequences formed by a plurality of ACKs/NACKs. For example, there are five PDSCHs, which are respectively decoded as NNAANs, where N represents the NACK and A represents the ACK. Decoding results of the five PDSCHs is used to form a 5-bit bit sequence. Then, the entire five bits are fed back to the network device.

In an implementation, a resource set of the PUCCH is first determined based on a codebook size. A maximum payload size (maxPayloadSize) in each resource set in a resource set combination associated with the terminal device divides a codebook size of UCI supported by the terminal device into several intervals. FIG. 3b is used as an example. The terminal device supports four resource sets. A maximum payload size indicated in a resource set 0 is 2 bits, a maximum payload size indicated in a resource set 1 is N2 bits, a maximum payload size indicated in a resource set 2 is N3 bits, and a maximum payload size indicated in a resource set 3 is N4 bits. In the four resource sets, a codebook size of the PUCCH that is supported by the terminal device is divided into four ranges: a codebook size is less than or equal to 2 bits, a codebook size is greater than 2 bits and less than or equal to N2 bits, a codebook size is greater than N2 bits and less than or equal to N3 bits, and a codebook size is greater than N3 bits and less than or equal to N4 bits. The four ranges respectively correspond to the resource set 0, the resource set 1, the resource set 2, and the resource set 3. A resource in a resource set is selected for sending in response to a codebook size of the ACK/NACK to be sent by the terminal belonging to a range. A specific value of N2, a specific value of N3, and a specific value of N4 is configured through the higher layer signaling. In an implementation, the resource set is configured through the network device.

Then, a specific resource in the resource set is selected based on dynamic indication information PRI in the DCI. The resource includes one or more of the following parameters: marking a resource identifier of the resource, a format of the PUCCH, and a time domain, a frequency domain, and an orthogonal code related to the format. A time-frequency resource used to feed back the ACK/NACK is determined based on a variable indicated in the resource.

In addition, in response to the PUCCH resource being determined from a specific resource set based on the PRI, in addition to the foregoing direct indication by using the PRI, the PRI and implicit indication are further supported. The PRI is generally three bits. In response to a quantity of PUCCH resources in a PUCCH resource set being greater than eight, the PUCCH resource set is divided into eight subsets (subsets). The PRI indicates which subset is selected, and a start control channel element (control channel element, CCE) of the PDCCH is used to implicitly indicate which resource in the subset is selected.

Based on the network architecture provided in FIG. 1, the following describes measurement of channel state information. Specifically, a channel quantity indicator (channel quantity indicator, CQI) is used as an example for description. As shown in FIG. 3c, the network device (the network device is an access network device, a core network device, or another network device) sends a CSI-RS to the terminal device. The terminal device receives the CSI-RS at a moment t1, and measures a channel based on the CSI-RS to obtain a CQI. The terminal device feeds back the CQI to the network device at a moment t2. The network device schedules downlink data at a moment t3 based on the received CQI. In other words, the network device uses the CQI measured by the terminal device at the moment t1 only at the moment t3. Because a channel changes with time, the CQI fed back by the terminal device is inaccurate. Because the CQI fed back by the terminal device does not accurately feed back channel state information of the current channel, high data reliability cannot be achieved in response to the network device performs data scheduling only based on the CQI fed back by the terminal device.

For example, an assumption is that a channel condition is good in response to the terminal device measuring the channel at the moment t1, but a channel state becomes poor in response to the network device actually scheduling data at the moment t3. In this case, in response to the network device performing data scheduling only based on the channel state information fed back by the terminal device, there is a high probability that an error occurs in data transmission. Therefore, the measured CQI cannot be used to accurately describe a channel state during data transmission.

In the conventional technology, to improve accuracy of channel measurement, an OLLA technology is used to track a current state of the channel. However, in response to the OLLA technology being applied to a scenario in which reliability of the data transmission is high, there is a low probability that the terminal device feeds back a NACK to the network device (for example, in some scenarios, the probability that the terminal device feeds back the NACK is 10⁻⁶. In this case, the network device sends 10⁶ pieces of downlink data to the terminal device, and the terminal device feeds back the NACK once). Therefore, the network device cannot effectively track the current state of the channel, and a high reliability use of data transmission cannot be ensured. Especially in an ultra-reliable and low latency communications (ultra-reliable and low latency communications, URLLC) scenario in which higher reliability is used, a problem of low reliability of the data transmission is particularly prominent.

To resolve the foregoing problem, embodiments described herein provide a communication method. The terminal device determines one or more downlink transmissions based on the downlink control information, determines the channel state information based on the one or more downlink transmissions indicated by downlink control, reports the channel state information to the network device, and enables the network device to adjust, based on the channel state information reported by the terminal device, a parameter used for data transmission. Therefore, reliability of the data transmission is improved by adjusting the parameter.

For ease of understanding by a person skilled in the art, related elements or technical terms in at least one embodiment are first briefly described herein.

### 1. Terminal Device

The terminal device is a mobile terminal device, such as a mobile phone (or referred to as a “cellular” phone) and a computer having a mobile terminal device, or is a portable, pocket-sized, handheld, computer-built-in, or vehicle-mounted mobile device, which exchanges language and/or data with a radio access network (radio access network, RAN) node. For example, the terminal device is: a mobile phone (mobile phone), a tablet computer, a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal device in self-driving (self-driving), a wireless terminal device in remote medical surgery (remote medical surgery), a wireless terminal device in a smart grid (smart grid), a wireless terminal device in transportation safety (transportation safety), a wireless terminal device in a smart city (smart city), or a wireless terminal device in a smart home (smart home).

### 2. Network Device

The network device is a device deployed in a radio access network to provide a wireless communication function for the terminal device. The network device includes various forms of macro base stations, micro base stations (also referred to as small stations), relay stations, access points, and the like. In systems using different radio access technologies, names of network devices is different. For example, in a global system for mobile communications (global system for mobile communications, GSM) or a code division multiple access (code division multiple access, CDMA) network, a network device is referred to as a base transceiver station (base transceiver station, BTS). In wideband code division multiple access (wideband code division multiple access, WCDMA), a network device is referred to as a NodeB (NodeB, NB). In a long term evolution (long term evolution, LTE) system, a network device is referred to as an evolved NodeB (evolved NodeB, eNB). Alternatively, the network device is a radio controller in a cloud radio access network (cloud radio access network, CRAN) scenario. Alternatively, the network device is a base station device in a new radio (new radio, NR) network. Alternatively, the network device is a wearable device or a vehicle-mounted device. Alternatively, the network device is a transmission and reception point (transmission and reception point, TRP).

### 3. CSI-RS

A downlink channel is generally measured through the CSI-RS. The network device sends the CSI-RS to the terminal device. After receiving the CSI-RS, the terminal device is used for channel measurement and interference measurement. The terminal device calculates, based on the received CSI-RS, an indicator that needs to be measured, for example, a rank indicator (rank indicator, RI), a pre-coding matrix indicator (pre-coding matrix indicator, PMI), or a CQI, and then reports the content. Two more important parts of a CSI-RS configuration are a CSI-RS reporting configuration (ReportConfig) and a CSI-RS resource configuration (ResourceConfig). The reporting configuration is used to configure a parameter related to channel reporting, for example, a reported type and a reported measurement index. The resource configuration is used to configure related information of a measured time-frequency resource.

Reported types of the channel state is classified into three types: periodic CSI (periodic CSI, P-CSI), semi-persistent CSI (semipersistent CSI, SP-CSI), and aperiodic CSI (aperiodic CSI, A-CSI). The P-CSI is configured by radio resource control (radio resource control, RRC), is periodically sent, and does not need to be triggered after the configuration. The SP-CSI is triggered through a media access control (media access control, MAC) control element (control element, CE) or DCI, and is sent periodically after the triggering. The A-CSI is triggered by DCI. After being triggered, the A-CSI is reported only once on a specified PUSCH in a specified slot. The DCI used to trigger the A-CSI is DCI used to trigger a physical uplink shared channel (physical uplink shared channel, PUSCH) of uplink data. FIG. 3d is a schematic diagram of reported types of three channel states.

The reported measured indexes includes a rank indicator, a pre-coding matrix indicator, a CQI, and the like. All or a part of the indexes is selected to be reported by configuring variables in the reporting configuration.

In addition, reporting of the channel states further supports wideband feedback and narrowband feedback. The wideband feedback represents that only one value is fed back in an entire reporting bandwidth, and the narrowband feedback represents that each subband (subband) is separately fed back. In addition, a size of each subband is specified in a protocol, and is specifically shown in Table 1. For a fixed bandwidth part (bandwidth part, BWP), a quantity of physical resource blocks (physical resource block, PRB) included in each subband is fixed. For example, in response to one BWP including 50 PRBs, a size of a subband of the BWP is 4 or 8. A specific one is specified by higher layer signaling. In addition, for the narrowband feedback, feedback is further performed discretely or continuously.

TABLE 1

| BWP (PRBs) | Size of a subband (PRBs) |
|---|---|
| <24 | N/A |
| 24-72 | 4, 8 |
| 73-144 | 8, 16 |
| 145-275 | 16, 32 |

Resources of the CSI-RS is also configured in three types: periodic, semi-persistent (semi-persistent), and aperiodic (aperiodic). There is a specific relationship between a reporting type of channel states and a configuration manner of a resource for measurement corresponding to the reporting type of channel states, which is specifically shown in Table 2. From Table 2, for a resource configured in a periodic type, reporting of the P-CSI, reporting of the SP-CSI, and reporting of the A-CSI is supported, while for an aperiodic resource, only aperiodic reporting is supported.

TABLE 2

| CSI-RS resource | P-CSI | SP-CSI | A-CSI |
|---|---|---|---|
| Periodicity | Support | Support | Support |
| Semi-persistent | Not support | Support | Support |
| Aperiodic | Not support | Not support | Support |

In addition, in terms of functions of the resources of the CSI-RS, the resources of the CSI-RS is classified into three types: NZP-CSI-RS for channel, ZP-CSI-RS for interference, and NZP-CSI-RS for interference.

The NZP-CSI-RS for channel represents an NZP-CSI-RS used for channel measurement.

The ZP-CSI-RS for interference represents the CSI-RS used for interference measurement. In response to the resources being configured, resources in the resource set are in a one-to-one correspondence with resources in a resource set of the NZP-CSI-RS for channel. The ZP-CSI-RS for interference is generally used for interference measurement. Therefore, ZP-CSI-RS for interference is also recorded as CSI-IM (channel state information-interference measurement).

The NZP-CSI-RS for interference represents the NZP-CSI-RS used for interference measurement.

The following further explains a difference between the ZP-CSI-RS and the NZP-CSI-RS.

The ZP-CSI-RS refers to a zero power CSI-RS, and essentially means that a target base station does not send any information on the configured ZP-CSI-RS, and the user performs detection on the resource. The detected signal is interference (because the target base station does not send any information). A difference between the NZP-CSI-RS and the ZP-CSI-RS lies in the NZP-CSI-RS. The target base station sends a known sequence on a configured resource, and a channel/interference is obtained through the known sequence.

The following describes configurations related to CSI-RS measurement. The configurations related to CSI-RS measurement mainly include a CSI-RS reporting configuration, a CSI-RS resource configuration, and the like.

a. The CSI-RS reporting configuration is mainly used to configure information related to CSI reporting. The following briefly describes several parameters related to at least one embodiment.

CSI-RS reporting configuration identifier (ReportConfigId): An identity document (identity document, ID) of a CSI-RS reporting configuration identifies the CSI-RS reporting configuration.

Configuring a resource of a CSI-RS used for channel measurement (resourcesForChannelMeasurement): Resource configuration is associated through a CSI-RS resource configuration identifier.

Configuring a resource of a CSI-RS used for interference measurement (CSI-IM-ResourcesForinterference): The CSI-RS resource configuration identifier is associated with the resource configuration, and the ZP-CSI-RS resource is also used to describe the resource used for interference measurement.

Configuring the NZP-CSI-RS resource used for interference measurement (nzp-CSI-RS-ResourcesForinterference): Resource configuration is associated through a CSI-RS resource configuration identifier.

A reporting type of CSI includes periodic reporting, semi-persistent reporting, and aperiodic reporting.

Reporting quantity (reportQuantity): The terminal device is selected to report different CSI information through different configurations, including a CSI-RS resource indicator (CSI-RS Resource Indicator, CRI), an RI, a PMI, a CQI, and the like.

b. The CSI-RS resource configuration is used to configure resource-related information used for CSI measurement. The following briefly describes several parameters related to at least one embodiment.

CSI-RS resource configuration identifier: ID of the CSI-RS resource configuration identifies the CSI-RS resource configuration, and is associated with the CSI-RS reporting configuration through the variable.

Configuring a resource-combining queue (CSI-RS-ResourceSetList): The queue includes a resource set used for channel measurement and a resource set used for interference measurement. The NZP-CSI-RS-ResourceSetld and/or the CSI-IM-ResourceSetld are associated with the configuration of the resource set. A main difference between a resource configured in an NZP-CSI-RS-ResourceSet and a resource configured in a CSI-IM-ResourceSet is that a CSI-RS of a known sequence is sent in an NZP-CSI-RS resource, and channel measurement or interference measurement is performed through the CSI-RS of the known sequence. The CSI-IM resource is also referred to as the ZP-CSI-RS resource. No information is sent on the resource, and all received information is interference.

Resource type (resourceType): The resource type is classified into a periodic resource, a semi-persistent resource, and an aperiodic resource.

c. NZP-CSI-RS-ResourceSet, configured to configure a CSI-RS resource set of the NZP, where the NZP-CSI-RS-ResourceSet includes at least one resource. The terminal device measures channel information based on these resources, and feeds back the channel information. In response to a plurality of resources existing in one resource set, a CRI variable fed back by the terminal device indicates a resource on which channel information obtained through measurement is specifically fed back by the terminal device, for example, CRI=0, which represents that the channel information fed back by the terminal device is channel information obtained through measurement on a resource whose resource id=0.

NZP-CSI-RS-ResourceSetld: represents an ID of the NZP-CSI-RS resource set.

NZP-CSI-RS-Resources: Resources included in the resource set are associated with each NZP-CSI-RS resource through the NZP-CSI-RS-Resourceld.

d. CSI-IM-ResourceSet: A resource set used for interference measurement is configured, which is similar to the NZP-CSI-RS-ResourceSet. Details are not described herein.

e. The NZP-CSI-RS-Resource is used to configure information related to the NZP-CSI-RS resource, and is associated with a resource set through the NZP-CSI-RS-Resourceld.

f. The CSI-IM-Resource is used to configure related information of a CSI-IM resource. The CSI-IM-Resource is associated with a CSI-IM resource set through the CSI-IM-Resourceld. The CSI-IM-Resource is similar to the NZP-CSI-RS resource, and details are not described herein again.

### 4. A Trigger Method for the A-CSI and the SP-CSI

Both the A-CSI and the SP-CSI is triggered through DCI and fed back on a PUSCH.

### a. A Trigger Method for the A-CSI

There is an indication field “CSI request” in the DCI, which indicates a trigger state (trigger state). In response to all bits in the indication field being set to 0, CSI is not triggered, to be specific, CSI measurement and feedback are not performed. Another state, for example, 01, corresponds to one trigger state from the configured trigger state set. The trigger state set is configured through a “CSI-AperiodicTriggerStateList”. For example, one trigger state list (trigger state list) is configured through an IE. The list includes a plurality of trigger states, each trigger state is associated with one CSI set, and one CSI set includes a plurality of pieces of CSI-AssociatedReportConfiglnfo. Each piece of CSI-AssociatedReportConfiglnfo in one CSI set is associated with a specific CSI-RS reporting configuration identifier and a channel/interference measurement resource.

### b. A Trigger Method for the SP-CSI

A DCI indication field includes a “CSI request”, which indicates one trigger state. A difference between the trigger method for the SP-CSI and the trigger method for the A-CSI: In response to all bits in the indication field being set to 0, a first trigger state in the trigger state set is triggered. The trigger state set is configured through a CSI-SemiPersistentOn-PUSCH-TriggerStateList. One trigger state is associated with one CSI-RS reporting configuration identifier.

### 5. Slot (Slot)

A format of a slot includes several orthogonal frequency division multiplexing (orthogonal frequency division multiplexing, OFDM) symbols. For example, a format of a slot includes 14 OFDM symbols, or a format of a slot includes 12 OFDM symbols; or a format of a slot includes seven OFDM symbols. All OFDM symbols in one slot is used for uplink transmission; and is used for downlink transmission; and some is used for downlink transmission, some is used for uplink transmission, and some are flexible time domain symbols (which is flexibly configured to be used for uplink or downlink transmission). The foregoing examples are merely examples for description, and shall not constitute any limitation of embodiments described herein. In consideration of system forward compatibility, a quantity of OFDM symbols included in the slot and the slot being used for uplink transmission and/or downlink transmission are not limited to the foregoing examples. In at least one embodiment, a time domain symbol is an OFDM symbol, to be specific, the time domain symbol is replaced with the OFDM symbol.

### 6. Time Unit

One time unit (which is also referred to as a time domain unit) is one time domain symbol or several time domain symbols, or one mini-slot (mini-slot), or one slot, or one sub-slot (sub-slot), or one subframe (subframe). Duration of one subframe in time domain is 1 millisecond (ms), one slot includes 7 or 14 time domain symbols, and one mini-slot includes at least one time domain symbol (for example, 2 time domain symbols, 7 time domain symbols, 14 time domain symbols, or any quantity of symbols less than or equal to 14 time domain symbols). Sizes of the foregoing time units are merely listed for ease of understanding the solutions in at least one embodiment, and should not be understood as a limitation in at least one embodiment. The sizes of the foregoing time units is other values, and this is not limited in at least one embodiment.

The time unit includes a time domain unit such as a radio frame (radio frame), a subframe, a slot, a mini-slot, a sub-slot, or an uplink symbol (symbol). In 5G NR, an uplink time domain symbol is referred to as an uplink symbol for short. A time domain length of one radio frame is 10 ms. One radio frame includes 10 radio subframes, and a time domain length of one radio subframe is 1 ms. One radio subframe includes one or more slots. Specifically, a quantity of slots included in one subframe is related to a subcarrier spacing. In response to a subcarrier spacing (subcarrier spacing, SCS) being 15 kHz, a time domain length of one slot is 1 ms. One slot includes 14 orthogonal frequency division multiplexing (orthogonal frequency division multiplexing, OFDM) uplink symbols.

### 7. Control Resource Set (Control Resource Set, CORESET)

The terminal device searches for and detect a PDCCH in one time-frequency resource set. The time-frequency resource set for detecting the PDCCH is configured through the network device. For example, the network device configures the time-frequency resource set (CORESET) for the terminal device through one information element (information element, IE). In an implementation, one time-frequency resource set pool index is configured for one time-frequency resource set, and a time-frequency resource set corresponding to a same time-frequency resource set pool index is grouped into one time-frequency resource set pool. a general consideration is that one time-frequency resource set pool corresponds to one TRP.

For example, an assumption is that the network device configures three time-frequency resource sets for the terminal device: a CORESET 0, a CORESET 1, and a CORESET 2. The CORESET 0 and the CORESET 1 are associated with coresetPoollndex=0, and the CORESET 2 is associated with coresetPoollndex=1. In this case, the CORESET 0 and the CORESET 1 form a group, and the CORESET 2 forms a group. In other words, the CORESET 0 and the CORESET 1 belong to a time-frequency resource set pool 0, and the CORESET 2 belongs to a time-frequency resource set pool 1.

### 8. Outer Loop Link Adaptation (Outer Loop Link Adaptation, OLLA)

An OLLA technology is a technology to overcome time-varying characteristics of a radio channel and improve performance of a system.

By using the OLLA technology, the network device performs link adaptation adjustment based on an ACK or a NACK corresponding to the downlink data fed back by the terminal device, to be specific, adjust a parameter used for scheduling data, for example, a signal-to-noise ratio (signal-to-noise ratio, SNR). The network device determines a corresponding modulation and coding scheme (modulation and coding scheme, MCS) based on the adjusted SNR, and schedules data by using the MCS, to track a current state of the channel to schedule data.

Specifically, how to adjust, based on the ACK or the NACK, the parameter used for scheduling data has different implementations for different parameters. For example, an example in which the parameter is the SNR is used, and the network device determines the SNR by using the following Formula (1):

SNR(i)=SNR_{CQI}+Δoffset(i) (1)

SNR(i) represents the SNR used by the network device in scheduling data for the i^{th} time, and the SNR used in scheduling data for the i^{th} time is also understood as an SNR used in scheduling data currently, and SNR(i−1) represents an SNR used in scheduling data for an (i−1)^{th} time or represents an SNR used in scheduling data last time. SNR_{CQI} represents an SNR determined by the network device based on a channel state fed back by the terminal device, for example, channel quality information (channel quality information, CQI). Δ_{offset}(i) represents the i^{th} time of OLLA adjustment amount, which meets the following Formula (2):

with Δ_{offset}(i)=Min{Δ_{offset}(i−1)+δ·1_{ACK}−9δ·1_{NACK},offsetₘₐₓ} (2)

Δ_{offset}(i−1) represents the (i−1)^{th} time of OLLA adjustment amount, and δ represents a step. The network device presets the step based on an actual usage. A larger step represents a larger step for adjusting the SNR each time. offsetₘₐₓ represents the OLLA adjustment amount, and the adjustment amount is a maximum value set by the system. 1_{ACK} and 1_{NACK} have different values in different cases. For example, in response to the network device receiving the ACK, 1_{ACK} is 1, and 1 NACK is 0. In response to the network device receiving the NACK, 1_{ACK} is 0, and 1_{NACK} is 1.

For example, an assumption is that SNR_{CQI}=20 dB, δ=1 dB, and Δ_{offset}(1)=0.

In response to the network device transmitting downlink data for the first time, SNR(1) of the scheduled data=SNR_{CQI}=20 dB.

The terminal device receives and decodes the downlink data, and feeds back the ACK to the network device in response to the decoding being correct.

In response to the network device transmitting the downlink data for the second time, SNR(2) of the scheduled data is 21 dB.

The terminal device receives and decodes the downlink data, and feeds back the ACK to the network device in response to the decoding being correct.

In response to the network device transmitting the downlink data for the third time, SNR(3) of the scheduled data is 22 dB.

The terminal device receives and decodes the downlink data, and feeds back the NACK to the network device in response to the decoding failing.

In response to the network device transmitting the downlink data for the fourth time, SNR(4) of the scheduled data is 13 dB.

From the foregoing that Δ_{offset} (i) is determined based on the ACK or the NACK fed back by the terminal device. Because SNR_{CQI} is inaccurate, the network device adjusts, based on an actual transmission condition of the channel, the SNR used by the scheduled data. In response to the data transmitted last time being correctly decoded, SNR_{CQI} is lower than the SNR during actual data transmission. Therefore, the SNR is increased a little during data scheduling this time, to track a change in a channel state well. For example, in response to the foregoing network device transmitting the downlink data for the second time, SNR_{CQI} is 20 dB, but SNR(2) of the actual scheduled data is 21 dB.

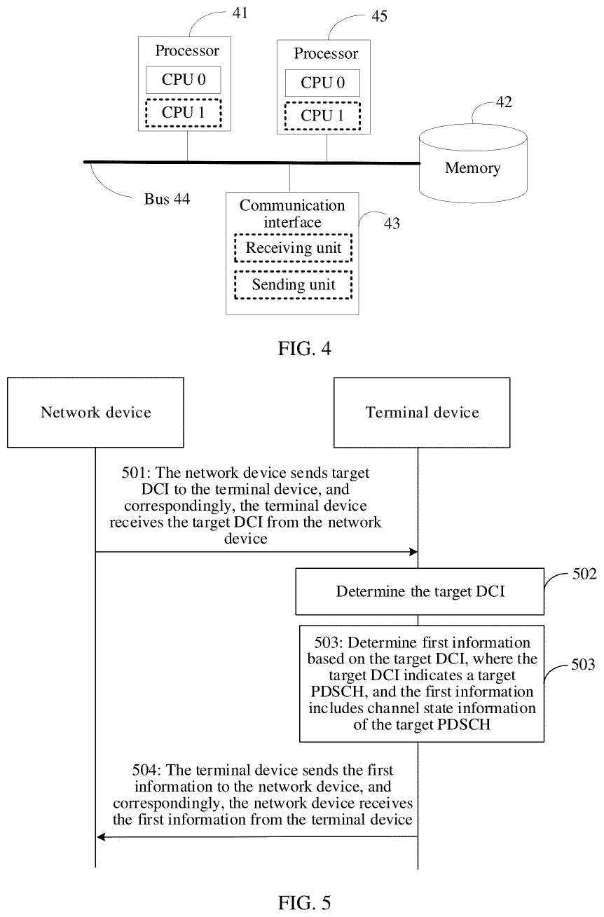

Basic hardware structures of the access network device, the core network device, and the terminal device are similar, and all include elements included in the communication apparatus shown in FIG. 4. The following describes the hardware structures of the access network device, the core network device, and the terminal device by using the communication apparatus shown in FIG. 4 as an example.

As shown in FIG. 4, the communication apparatus includes a processor 41, a memory 42, a communication interface 43, and a bus 44. The processor 41, the memory 42, and the communication interface 43 is connected through the bus 44.

As shown in FIG. 4, the communication apparatus includes a processor 41, a memory 42, a communication interface 43, and a bus 44. The processor 41, the memory 42, and the communication interface 43 is connected through the bus 44.

The processor 41 is a control center of the communication apparatus, and is one processor or is a collective name of a plurality of processing elements. For example, the processor 41 is a general-purpose central processing unit (central processing unit, CPU), or is another general-purpose processor. The general-purpose processor is a microprocessor, any conventional processor, or the like.

In an embodiment, the processor 41 includes one or more CPUs, for example, a CPU 0 and a CPU 1 shown in FIG. 4.

In an embodiment, the communication apparatus includes a plurality of processors, for example, the processor 41 and the processor 45 shown in FIG. 4. Each of the processors is a single-core processor (single-CPU) or is a multi-core processor (multi-CPU). The processor herein is one or more devices, circuits, and/or processing cores configured to process data (for example, computer instructions).

The memory 42 is a read-only memory (read-only memory, ROM) or another type of static storage device capable of storing static information and instructions, a random access memory (random access memory, RAM) or another type of dynamic storage device capable of storing information and instructions, an electrically erasable programmable read-only memory (electrically erasable programmable read-only memory, EEPROM), a magnetic disk storage medium or another magnetic storage device, or any other medium capable of carrying or storing expected program code in a form of an instruction or data structure and capable of being accessed by a computer, but is not limited thereto.

In at least one embodiment, the memory 42 exists independently of the processor 41. The memory 42 is connected to the processor 41 through the bus 44, and is configured to store instructions or program code. In response to invoking and executing the instructions or the program code stored in the memory 42, the processor 41 implements the communication method provided in the following embodiments.

In at least one embodiment, the memory 42 is alternatively integrated with the processor 41.

The communication interface 43 is configured to connect the communication apparatus to another device through a communication network. The communication network is an Ethernet, a RAN, a wireless local area network (wireless local area networks, WLAN), or the like. The communication interface 43 includes a receiving unit configured to receive data and a sending unit configured to send data.

The bus 44 is an industry standard architecture (industry standard architecture, ISA) bus, a peripheral component interconnect (peripheral component interconnect, PCI) bus, an extended industry standard architecture (extended industry standard architecture, EISA) bus, or the like. The bus is classified into an address bus, a data bus, a control bus, and the like. For ease of representation, only one thick line is used to represent the bus in FIG. 4, but this does not mean that there is only one bus or only one type of bus.

A structure shown in FIG. 4 does not constitute a limitation on the communication apparatus. In addition to the components shown in FIG. 4, the communication apparatus includes more or fewer components than those shown in the figure, or combine some components, or have different component arrangements.

Based on the foregoing descriptions of structures of the communication system and the communication apparatus, embodiments described herein provide a communication method. The following describes the communication method provided in at least one embodiment with reference to the accompanying drawings.

As shown in FIG. 5, the communication method includes the following step 501 to step 504.

501. A network device sends target DCI to a terminal device, and correspondingly, the terminal device receives the target DCI from the network device.

Specifically, the target DCI belongs to one first DCI set, and the first DCI set includes only one piece of downlink control information, or includes a plurality of pieces of downlink control information. In response to the first DCI set including only one piece of DCI, first DCI is the target DCI; and in response to the first DCI set including a plurality of pieces of downlink control information, the target DCI is one piece of DCI in the first DCI set.

In at least one embodiment, the first DCI set is determined through a preconfigured time window. The preconfigured time window is predefined, or is indicated by the network device to the terminal device through signaling. DCI in the time window belongs to the first DCI set, or a PDSCH in the time window belongs to a first PDSCH set. The first DCI set is associated with the first PDSCH set. For example, an association relationship is: DCI for scheduling a PDSCH in the first PDSCH set belongs to the first DCI set, or a PDSCH scheduled by DCI in the first DCI set belongs to the first PDSCH set.

In at least one embodiment, the first DCI set is determined through a preconfigured periodicity (T). A time unit set is determined based on the periodicity, and DCI sent in the time unit set belongs to the first DCI set. Alternatively, a PDSCH sent in the time unit set belongs to the first PDSCH set, and the first DCI set is associated with the first PDSCH set. For example, the association relationship is that DCI for scheduling a PDSCH in the first PDSCH set belongs to the first DCI set, or a PDSCH scheduled by DCI in the first DCI set belongs to the first PDSCH set.

The time unit is one time domain symbol or several time domain symbols, or a mini-slot, or a slot, or a sub-slot, or a subframe. This is not limited in at least one embodiment.

For example, an example in which the time unit is a slot is used. An assumption is that the periodicity T is five slots, a slot 0, a slot 5, a slot 10, and the like is determined as the time unit set. DCI sent in the slot 0, the slot 5, and the slot 10 forms the first DCI set.

For another example, based on the periodicity T, offset (offset) information is further configured. The terminal device determines the time unit set through the periodicity and an offset, and the DCI sent in the time unit set belongs to the first DCI set. Alternatively, a PDSCH sent in the time unit set belongs to the first PDSCH set, and the first DCI set is associated with the first PDSCH set. For example, the association relationship is that DCI for scheduling a PDSCH in the first PDSCH set belongs to the first DCI set, or a PDSCH scheduled by DCI in the first DCI set belongs to the first PDSCH set. For example, in response to the periodicity T being five slots, and the offset is one slot, a determination is made that a slot 1, a slot 6, a slot 11, and the like are the time unit set. DCI sent in the slot 1, the slot 6, and the slot 11 forms the first DCI set.

For another example, one time period X is further configured. Based on the time unit set determined by the periodicity and/or the offset, one time unit subset is further determined through a time period. In other words, in the time unit set determined by the periodicity and/or the offset, time units that are also located in the time period X are the time unit subset, and the DCI sent in the time unit subset belongs to the first DCI set. Alternatively, the PDSCH sent in the time unit subset belongs to the first PDSCH set, and the first DCI set is associated with the first PDSCH set. For example, the association relationship is that DCI for scheduling a PDSCH in the first PDSCH set belongs to the first DCI set, or a PDSCH scheduled by DCI in the first DCI set belongs to the first PDSCH set.

For example, in response to the time period X being any one of 11, 12, 13, 14, and 15, in response to the time unit set being a slot 1, a slot 6, a slot 11, a slot 16, a slot 21, and the like, with reference to the time period, one time unit subset that is the slot 1, the slot 6, and the slot 11 is obtained. Therefore, the DCI sent in the slot 1, the slot 6, and the slot 11 is the first DCI set, or the PDSCH sent in the slot 1, the slot 6, and the slot 11 is the first PDSCH set. The first DCI set is associated with the first PDSCH set.

For another example, one quantity Y of time units is further configured. Based on the time unit set determined by the periodicity and/or the offset, one time unit subset is further determined through the quantity Y of time units. In other words, in a time unit set determined by the periodicity and/or the offset, Y time units are the time unit subset, and the DCI sent in the time unit subset belongs to the first DCI set. Alternatively, the PDSCH sent in the time unit subset belongs to the first PDSCH set, and the first DCI set is associated with the first PDSCH set. For example, the association relationship is that DCI for scheduling a PDSCH in the first PDSCH set belongs to the first DCI set, or a PDSCH scheduled by DCI in the first DCI set belongs to the first PDSCH set.

For example, the quantity Y of time units is 3. In this case, in response to the time unit set being a slot 1, a slot 6, a slot 11, a slot 16, a slot 21, and the like, with reference to the time period, one time unit subset that is the slot 1, the slot 6, and the slot 11 is obtained. Therefore, the DCI sent in the slot 1, the slot 6, and the slot 11 is the first DCI set, or the PDSCH sent in the slot 1, the slot 6, and the slot 11 is the first PDSCH set. The first DCI set is associated with the first PDSCH set.

In addition, with reference to another method, the first DCI set is further determined through the time window, the periodicity, the offset, and the time period. This is not limited in at least one embodiment.

For example, in the foregoing method, is further specified that the first DCI set includes the DCI determined under the foregoing condition and existing before a time point.

The DCI or the PDSCH in the time window or the time unit set is dynamically scheduled, or is semi-persistently scheduled, or is both dynamically scheduled and semi-persistently scheduled.

In at least one embodiment, in response to performing dynamic scheduling, the network device sends, to the terminal device, the first DCI for scheduling one PDSCH or the first DCI set for scheduling a plurality of PDSCHs.

Optionally, during semi-persistent scheduling, the network device determines the plurality of PDSCHs as one PDSCH set by activating DCI used for semi-persistent scheduling.

Optionally, the first DCI set is determined based on a time unit in which feedback information of the plurality of PDSCHs is located. Alternatively, the plurality of PDSCHs whose feedback information is located in a same time unit is determined as a first PDSCH set, and DCI used for scheduling at least two PDSCHs in the first PDSCH set is determined as the first DCI set. Further, optionally, the feedback information of the plurality of PDSCHs is ACK/NACK feedback information. Optionally, the first DCI set is determined based on a time unit in which feedback information of the plurality of PDSCHs is located. Alternatively, the plurality of PDSCHs whose feedback information is located in a same time unit is determined as the first PDSCH set, and DCI for scheduling one PDSCH in the first PDSCH set is determined as the first DCI set. Further, optionally, the feedback information of the plurality of PDSCHs is ACK/NACK feedback information.

The first DCI set is determined based on a time unit in which the ACK/NACK of the plurality of PDSCHs is located. Further, optionally, ACK/NACK feedback information corresponding to scheduled downlink data in the first DCI set is located in a same time unit. For example, the network device sends five pieces of DCI, which are DCI 1, DCI 2, DCI 3, DCI 4, and DCI 5 respectively, and each piece of DCI schedules one PDSCH, which is a PDSCH 1, a PDSCH 2, a PDSCH 3, a PDSCH 4, and a PDSCH 5 respectively. ACK/NACK feedback information corresponding to the PDSCH 1, the PDSCH 3, and the PDSCH 5 is fed back in the time unit 1, and ACK/NACK feedback information corresponding to the PDSCH 2 and the PDSCH 4 is fed back in the time unit 2. Therefore, the DCI 1, the DCI 3, and the DCI 5 belong to the first DCI set.

Optionally, at least two PDSCHs corresponding to the ACK/NACK feedback information located in one time unit (for example, a first time unit) belong to the first PDSCH set. The at least two PDSCHs corresponding to the ACK/NACK in one time unit belong to the first PDSCH set, and the first PDSCH set includes only a PDSCH whose ACK/NACK feedback information is located in one time unit, or the first PDSCH set includes a PDSCH whose ACK/NACK feedback information is located in one time unit, and further includes another PDSCH. In other words, in this case, ACK/NACK feedback information of some PDSCHs in the first PDSCH set is in a same time unit. The first PDSCH set further includes another PDSCH, and is determined in another manner. This is not limited herein.

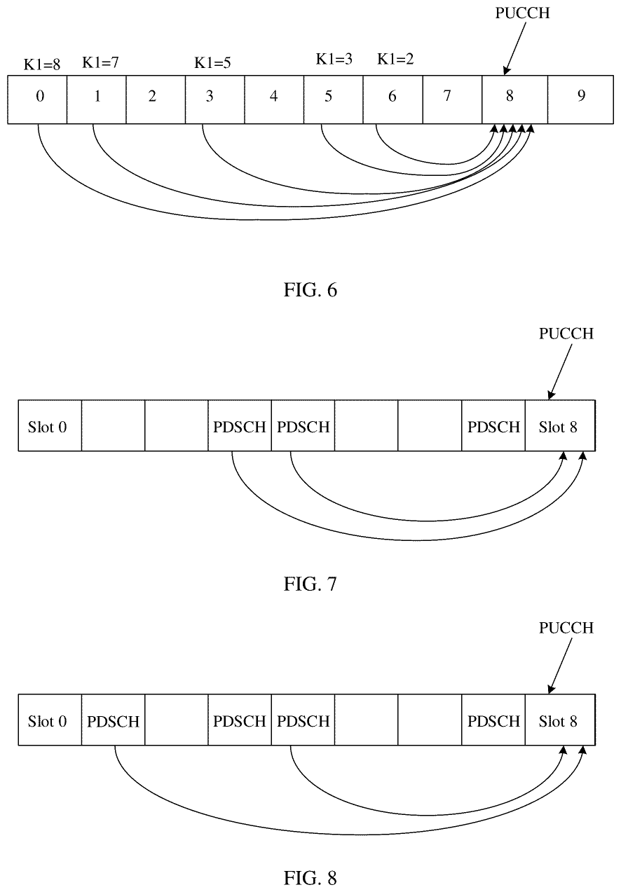

For example, an assumption is that the time unit is a slot, as shown in FIG. 6, five ACKs/NACKs located in an eighth slot correspond to five PDSCHs in slots 0, 1, 3, 5, and 6, and the first PDSCH set includes the five PDSCHs.

For another example, an assumption is that the time unit is a slot, and two ACKs are located in an eighth slot. As shown in FIG. 7, PDSCHs corresponding to the two ACKs are respectively located in a third slot and a fourth slot. The first PDSCH set includes three PDSCHs located in the third slot, the fourth slot, and a seventh slot. As shown in FIG. 8, PDSCHs corresponding to two ACKs are respectively located in a first slot and a fourth slot, and a first PDSCH set includes three PDSCHs located in a third slot, the fourth slot, and a seventh slot.

After the first PDSCH set is determined, the first DCI set is determined based on the first PDSCH set. In other words, DCI for scheduling a PDSCH in the first PDSCH set belongs to the first DCI set, or a PDSCH scheduled by DCI in the first DCI set belongs to the first PDSCH set.

The first PDSCH set has an association relationship with the first DCI set. In other words, DCI for scheduling a PDSCH in the first PDSCH set belongs to the first DCI set, or a PDSCH scheduled by DCI in the first DCI set belongs to the first PDSCH set. There is the following relationship.

All PDSCHs in the first PDSCH set are associated with all pieces of DCI in the first DCI set. For example, the first PDSCH set includes five PDSCHs, the first DCI set includes five pieces of DCI, and one piece of DCI is used to schedule one PDSCH.

Alternatively, some PDSCHs in the first PDSCH set are associated with all pieces of DCI in the first DCI set. For example, the first PDSCH includes five PDSCHs, two PDSCHs of the five PDSCHs are separately scheduled by two pieces of DCI, the other three PDSCHs is PDSCHs in semi-persistent scheduling, and the first DCI set includes the two pieces of DCI.

Alternatively, all PDSCHs in the first PDSCH set are associated with some pieces of DCI in the first DCI set. For example, the first PDSCH includes five PDSCHs, and each of the five PDSCHs is scheduled by using the DCI. There is five pieces of DCI, and the first DCI set includes: six or more pieces of DCI including the five pieces of DCI, where DCI other than the five pieces of DCI is used to schedule other data.

Optionally, the first PDSCH set is determined through second DCI, where the second DCI indicates a time-frequency resource used to feed back the ACK/NACK. The at least two PDSCHs corresponding to the ACK feedback information or the NACK feedback information fed back on the time-frequency resource is determined as the first PDSCH set. Optionally, after the first PDSCH set is determined, the first DCI set is determined based on the first PDSCH set. For an association relationship between the first PDSCH set and the first DCI set, refer to the foregoing description. Details are not described herein again.

Optionally, the first PDSCH set is determined through the second DCI. The second DCI indicates a time-frequency resource used for a feedback information set. The feedback information set includes at least one piece of feedback information. At least one piece of feedback information in the feedback information set corresponds to a PDSCH in the first PDSCH set. The feedback information is an ACK/NACK. Optionally, after the first PDSCH set is determined, the first DCI set is determined based on the first PDSCH set. For an association relationship between the first PDSCH set and the first DCI set, refer to the foregoing description. Details are not described herein again. Optionally, the first DCI set includes third DCI. The third DCI indicates a second feedback information set. The second feedback information set includes at least one piece of feedback information. A PDSCH corresponding to the at least one piece of feedback information included in the second feedback information set belongs to the first PDSCH set.

Further, optionally, PDSCHs corresponding to all feedback information included in the second feedback information set belong to the first PDSCH set.

The DCI in the first DCI set or the PDSCH in the first PDSCH set is dynamically scheduled, or is semi-persistently scheduled, or is both dynamically scheduled and semi-persistently scheduled.

In at least one embodiment, in addition to the plurality of implementations described above, the association relationship between the first PDSCH set and the first DCI set is further configured through higher layer information, predefined, or specified in a protocol, or is another manner in implementing the association relationship. This is not limited in at least one embodiment.

502. The terminal device determines target DCI.

Specifically, in response to the first DCI being one piece of downlink control information, the first DCI is the target DCI. In response to the first DCI being a plurality of pieces of downlink control information, to be specific, in step 501, the network device sends the first DCI set, and the terminal device determines the target DCI in the first DCI set.

For the first DCI set, the terminal device determines the target DCI from the first DCI set according to a preset rule. Optionally, the preset rule is a rule in a frequency domain dimension, a time dimension, a TRP dimension, or a combination of at least two of a frequency domain dimension, a time dimension, and a TRP dimension.

Optionally, the target DCI is DCI that is sorted in the first DCI set based on any one of the time dimension, the frequency domain dimension, or the TRP dimension and that meets the following condition: The target DCI is DCI in which time is in the last, or the target DCI is DCI in which frequency domain is in the last, or the target DCI is DCI in which a TRP is in the last. Alternatively, the target DCI is DCI that is in the first DCI set and that is sorted based on a combination of at least two of a time dimension, a frequency domain dimension, and a TRP dimension and that meets the following condition: The target DCI is DCI in which time is in the last and frequency domain is in the last, or the target DCI is DCI in which a TRP is in the last and frequency domain is in the last, or the target DCI is DCI in which a TRP is in the last and time is in the last, or the target DCI is DCI in which time is in the last, frequency domain is in the last, and a TRP is in the last. The time in the last is also understood as a last index of the time units obtained after indexes of the time units are sorted in ascending or descending order, or a last moment of DCI detection moments obtained after the DCI detection moments are sorted in ascending or descending order. Frequency domain in the last is also understood as a last index of frequency domain units obtained after the indexes of the frequency domain units are sorted in ascending or descending order. The TRP in the last is also understood as a last time-frequency resource set pool index obtained after the time-frequency resource set pool indexes are sorted in ascending or descending order.

Manner 1: In response to the preset rule being a rule in the frequency domain dimension, the preset rule is that the target DCI is an N^{th} piece of DCI in the first DCI set that is obtained after indexes of the frequency domain unit are sorted in ascending or descending order, where N is a positive integer. For example, in response to N being 1, the target DCI is the first piece of DCI in the first DCI set that is obtained after indexes of the frequency domain unit are sorted in ascending or descending order. For another example, in response to N being the same as a quantity of pieces of DCI included in the first DCI set, the target DCI is a last piece of DCI in the first DCI set that is obtained after indexes of the frequency domain unit are sorted in ascending or descending order. The frequency domain unit is a cell, a carrier (carrier), a bandwidth part (bandwidth part, BWP), or the like. This is not limited in at least one embodiment.

Manner 2: In response to the preset rule being a rule in the time dimension, the preset rule is that the target DCI is an N^{th} piece of DCI in the first DCI set that is obtained after indexes of a time unit are sorted in ascending or descending order, where N is a positive integer. The ascending order of the indexes of the time unit is also understood as ascending order of time, and the descending order of the indexes of the time unit is also understood as descending order of time. For example, in response to N being 1, the target DCI is the first piece of DCI in the first DCI set that is obtained after the indexes of the time unit are sorted in ascending or descending order. For another example, in response to N being the same as a quantity of pieces of DCI included in the first DCI set, the target DCI is a last piece of DCI in the first DCI set that is obtained after the indexes of the time unit are sorted in ascending or descending order. The time unit is a system frame, a subframe, a slot, an OFDM symbol, or the like. This is not limited in at least one embodiment. Alternatively, the preset rule is that: The target DCI is the N^{th} piece of DCI in the first DCI set that is obtained after DCI detection moments are sorted in ascending or descending order, where N is a positive integer. The ascending order of the DCI detection moment is also understood as ascending order of time, and the descending order of the DCI detection moment is also be understood as descending order of time. For example, in response to N being 1, the target DCI is the first piece of DCI in the first DCI set that is obtained after DCI detection moments are sorted in ascending or descending order. For another example, in response to N being the same as a quantity of pieces of DCI included in the first DCI set, the target DCI is a last piece of DCI in the first DCI set that is obtained after the DCI detection moments are sorted in ascending or descending order. The DCI detection moment is a start moment of a time-frequency resource corresponding to the DCI, or is an end moment of a time-frequency resource corresponding to the DCI.

Manner 3: In response to the preset rule being a rule in the TRP dimension, the preset rule is that the target DCI is an N^{th} piece of DCI in the first DCI set that is obtained after time-frequency resource set pool indexes are sorted in ascending or descending order, where N is a positive integer. For example, in response to N being 1, the target DCI is the first piece of DCI in the first DCI set that is obtained after the time-frequency resource set pool indexes are sorted in ascending or descending order. For another example, in response to N being the same as a quantity of pieces of DCI included in the first DCI set, the target DCI is a last piece of DCI in the first DCI set that is obtained after the time-frequency resource set pool indexes are sorted in ascending or descending order.

There is one preset rule, for example, any rule of any dimension in the foregoing three manners, or there is a plurality of preset rules. Further, optionally, in response to there being a plurality of preset rules, the plurality of preset rules is a combination of at least two rules of at least two dimensions in the foregoing three manners.

Example 1: In response to the preset rule being a rule in the time dimension and the frequency domain dimension, the preset rule is that the target DCI is the N^{th} piece of DCI in the first DCI set that is obtained after all pieces of DCI are sorted first based on the time dimension and then the frequency domain dimension, where N is a positive integer. The time dimension is a manner in which the indexes of the time unit are sorted in ascending or descending order in the first DCI set, or a manner in which the DCI detection moments are sorted in ascending or descending order in the first DCI set. The frequency domain dimension is a manner in which the indexes of the frequency domain unit are sorted in ascending or descending order in the first DCI set. The ascending order of the DCI detection moment is also understood as ascending order of time, and the descending order of the DCI detection moment is also understood as descending order of time. Any time dimension and any frequency domain dimension is combined as a preset rule. This is not limited in at least one embodiment. For example, in response to N being 1, in response to the preset rule being that the first DCI set is sorted first based on the time dimension and then based on the frequency domain dimension, the target DCI is first piece of DCI in the first DCI set that is obtained after the indexes of the time unit are sorted in ascending or descending order, and after indexes of the frequency domain unit in a same time unit are sorted in ascending or descending order. Alternatively, the target DCI is the first piece of DCI in the first DCI set that is obtained after the DCI detection moments are sorted in ascending or descending order, and after the indexes of the frequency domain unit at a same DCI detection moment are sorted in ascending or descending order. In response to the preset rule being that the first DCI set is sorted first based on the frequency domain dimension and then based on the time dimension, the target DCI is the first piece of DCI in the first DCI set that is obtained after the indexes of the frequency domain unit are sorted in ascending or descending order, and after the indexes of the time unit in a same frequency domain unit are sorted in ascending or descending order. Alternatively, the target DCI is the first piece of DCI in the first DCI set that is obtained after the indexes of the frequency domain unit are sorted in ascending or descending order, and after the DCI detection moments in a same frequency domain unit are sorted in ascending or descending order. For another example, in response to N being the same as a quantity of pieces of DCI included in the first DCI set, in response to the preset rule being that the first DCI set is sorted first based on the time dimension and then based on the frequency domain dimension, the target DCI is a last piece of DCI in the first DCI set that is obtained after the indexes of the time unit are sorted in ascending or descending order, and after the indexes of the frequency domain unit in a same time unit are sorted in ascending or descending order. Alternatively, the target DCI is the last piece of DCI in the first DCI set that is obtained after the DCI detection moments are sorted in ascending or descending order, and after the indexes of the frequency domain unit at a same DCI detection moment are sorted in ascending or descending order. In response to the preset rule being that the first DCI set is sorted first based on the frequency domain dimension and then based on the time dimension, the target DCI is the last piece of DCI in the first DCI set that is obtained after the indexes of the frequency domain unit are sorted in ascending or descending order, and after the indexes of the time unit in a same frequency domain unit are sorted in ascending or descending order. Alternatively, the target DCI is the last piece of DCI in the first DCI set that is obtained after the indexes of the frequency domain unit are sorted in ascending or descending order, and after the DCI detection moments in a same frequency domain unit are sorted in ascending or descending order.

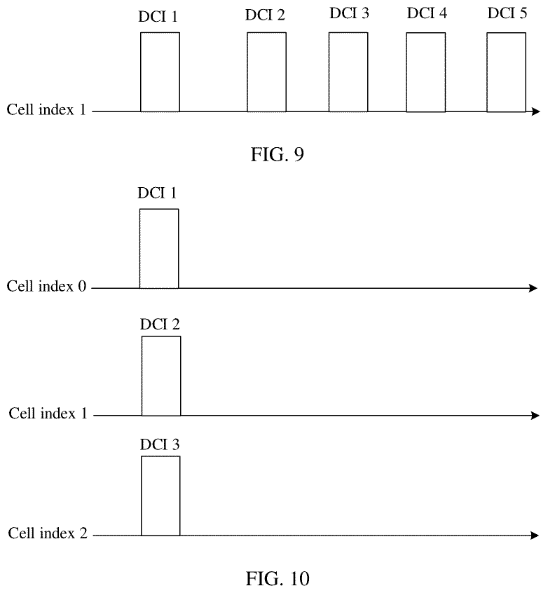

Example 2: The preset rule is in a time dimension. For example, as shown in FIG. 9, a cell index corresponding to a cell 1 is 1. The first DCI set includes five pieces of DCI, to be specific, the terminal device located in the cell 1 receives five pieces of DCI at five different moments. The five pieces of DCI are sorted in time sequence as follows: DCI 1, DCI 2, DCI 3, DCI 4, and DCI The time point herein is a time point at which the network device sends the DCI, or is a time point at which the terminal device receives the DCI. This is not limited herein. Specifically, an example in which the terminal device receives the DCI is used. The time point herein is a start moment at which the DCI is detected, or is an end moment at which the DCI is detected. For another example, an example in which the terminal device sends the DCI is used. The time point herein is a start moment at which the DCI is sent, or is an end moment at which the DCI is sent.

In response to the preset rule being that the target DCI is the first piece of DCI in the first DCI set that is obtained after sorting is performed based on a time sequence, the target DCI is the DCI 1.

In response to the preset rule being that the target DCI is the last piece of DCI in the first DCI set that is obtained after sorting is performed based on a time sequence, the target DCI is the DCI 5.

In response to the preset rule being that the target DCI is the N^{th} piece of DCI in the first DCI set that is obtained after sorting is performed based on a time sequence, where N is an N^{th} piece of DCI in a positive order or in a reverse order. An example in which N is 2 is used. In response to the target DCI being a second piece of DCI in a positive order in the first DCI set that is obtained after sorting is performed based on a time sequence, the target DCI is the DCI 2. In response to the target DCI being a second piece of DCI in a reverse order in the first DCI set that is obtained after sorting is performed based on a time sequence, the target DCI is the DCI 4.

Optionally, an application scenario of Example 2 is a single-TRP and single-cell scenario. In this case, all pieces of DCI received by the terminal device belongs to one cell. The frequency domain dimension is able to not be considered in the preset rule.

Example 3: The preset rule is in a time dimension and a frequency domain dimension. Optionally, the preset rule is: The target DCI is the first DCI or the last DCI that is obtained after all pieces of DCI in the first DCI set are sorted first based on the time dimension and then the frequency domain dimension. The time dimension is in ascending order of time or in descending order of time, and the frequency domain dimension is in ascending order of cell indexes or in descending order of cell indexes, namely, in ascending order of cell indexes or in descending order of cell indexes. Any time dimension and any cell index dimension is combined as a preset rule. This is not limited in at least one embodiment. Specifically, the preset rule is that the target DCI is the first piece of DCI or the last piece of DCI that is obtained after all pieces of DCI in the first DCI set are first sorted in ascending order of time, and then cells in which DCI at each time point is located are sorted in ascending order of cell indexes. Alternatively, the preset rule is that the target DCI is the first piece of DCI or the last piece of DCI that is obtained after all pieces of DCI in the first DCI set are first sorted in ascending order of time, and then cells in which DCI at each time point is located are sorted in descending order of cell indexes. Alternatively, the preset rule is that the target DCI is the first piece of DCI or the last piece of DCI that is obtained after all pieces of DCI in the first DCI set are first sorted in descending order of time, and then cells in which DCI at each time point is located are sorted in ascending order of cell indexes. Alternatively, the preset rule is that the target DCI is the first piece of DCI or the last piece of DCI that is obtained after all pieces of DCI in the first DCI set are first sorted in descending order of time, and then cells in which DCI at each time point is located are sorted in descending order of cell indexes. Alternatively, the preset rule is that the target DCI is the first piece of DCI or the last piece of DCI that is obtained after all pieces of DCI in the first DCI set are first sorted in ascending order of cell indexes, and then all pieces of DCI in each cell are sorted in ascending order of time. Alternatively, the preset rule is that the target DCI is the first piece of DCI or the last piece of DCI that is obtained after all pieces of DCI in the first DCI set are first sorted in ascending order of cell indexes, and then all pieces of DCI in each cell are sorted in ascending order of time. Alternatively, the preset rule is that the target DCI is the first piece of DCI or the last piece of DCI that is obtained after all pieces of DCI in the first DCI set are first sorted in descending order of cell indexes, and then all pieces of DCI in each cell are sorted in ascending order of time. Alternatively, the preset rule is that the target DCI is the first piece of DCI or the last piece of DCI that is obtained after all pieces of DCI in the first DCI set are first sorted in descending order of cell indexes, and then all pieces of DCI in each cell are sorted in descending order of time. Optionally, the application scenario of Example 3 is a single-TRP and multi-cell scenario. Because there is more than one cell, to distinguish between different cells, each cell in the plurality of cells correspond to one identifier, and the identifier is also understood as a cell index. The time dimension and the frequency dimension need to be considered in the preset rule.

For example, as shown in FIG. 10, cell indexes corresponding to three cells are respectively: 0, 1, and 2. A first DCI set includes three pieces of DCI. An assumption is that terminal devices simultaneously located in three cells receive, at a same moment, three pieces of DCI located in the three cells. The three DCI pieces that are sorted in ascending order of cell indexes are: DCI 1, DCI 2, and DCI 3.

In response to the preset rule being that the target DCI is the first piece of DCI that is obtained after all pieces of DCI in the first DCI set are first sorted in ascending order of time, and then cells in which DCI at each time point is located are sorted in ascending order of cell indexes, the target DCI is the DCI 1.

In response to the preset rule is that the target DCI is the first piece of DCI that is obtained after all pieces of DCI in the first DCI set are first sorted in descending order of cell indexes, and then all pieces of DCI in each cell are sorted in descending order of time, the target DCI is the DCI 3.

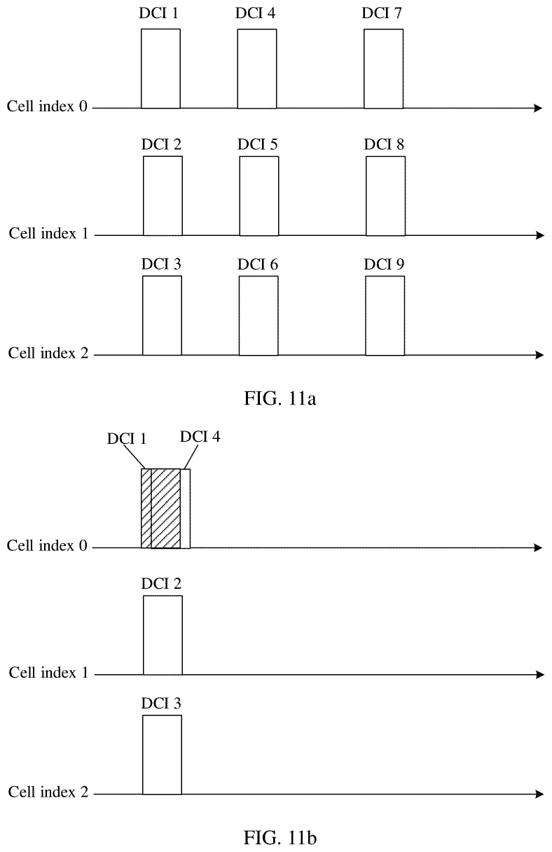

For another example, as shown in FIG. 11a, cell indexes corresponding to the three cells are respectively: 0, 1, and 2. The first DCI set includes nine pieces of DCI. An assumption is that terminal devices simultaneously located in the three cells receive, at each of the three moments, three pieces of DCI located in the three cells.

In response to the preset rule being that the target DCI is the first piece of DCI that is obtained after all pieces of DCI in the first DCI set are first sorted in ascending order of time, and then cells in which DCI at each time point is located are sorted in ascending order of cell indexes, a final sequence of the nine pieces of DCI is: DCI 1, DCI 2, DCI 3, DCI 4, DCI 5, DCI 6, DCI 7, DCI 8, and DCI 9, and the target DCI is the DCI 1.

In response to the preset rule being that the target DCI is the last piece of DCI that is obtained after all pieces of DCI in the first DCI set are first sorted in ascending order of cell indexes, and then all pieces of DCI in each cell are sorted in ascending order of time, a final sequence of the nine pieces of DCI is: DCI 1, DCI 4, DCI 7, DCI 2, DCI 5, DCI 8, DCI 3, DCI 6, and DCI 9, and the target DCI is the DCI 9.

In response to the preset rule being that the target DCI is the N^{th} piece of DCI that is obtained after all pieces of DCI in the first DCI set are first sorted in ascending order of cell indexes, and then all pieces of DCI in each cell are sorted in ascending order of time. N is an N^{th} piece of DCI in a positive order or in a reverse order. A final sequence of the nine pieces of DCI is: DCI 1, DCI 4, DCI 7, DCI 2, DCI 5, DCI 8, DCI 3, DCI 6, and DCI 9. An example in which N is 2 is used. In response to the second piece of DCI being the second piece of DCI in a positive order, the target DCI is the DCI 4. In response to the second piece of DCI being the second piece of DCI in a reverse order, the target DCI is the DCI 6.

Example 4 In a multi-TRP scenario, because there is more than one TRP, to distinguish between different TRPs, each of the plurality of TRPs corresponds to one identifier, and the identifier is a time-frequency resource set pool index. In this case, the preset rule is that the target DCI is the N^{th} piece of DCI that is obtained after all pieces of DCI in the first DCI set are first sorted based on a time dimension and a frequency domain dimension, and then all pieces of DCI in a same cell and at a same time point are sorted in ascending or descending order of time-frequency resource set pool indexes. N is a positive integer. Alternatively, the preset rule is that the target DCI is the N^{th} piece of DCI that is obtained after all pieces of DCI in the first DCI set are first sorted in ascending or descending order of time-frequency resource set pool indexes, and then, all pieces of DCI corresponding to each time-frequency resource set pool index are sorted based on the time dimension and the frequency domain dimension. For specific descriptions of sorting in the time dimension and the frequency domain dimension, refer to related descriptions in Example 2. Details are not described herein again.

For example, as shown in FIG. 11b, cell indexes corresponding to three cells are respectively: 0, 1, and 2. A first DCI set includes four pieces of DCI. An assumption is that terminal devices simultaneously located in three cells receive, at a same moment, four pieces of DCI located in the three cells. The terminal device receives, at a same moment, two pieces of DCI that are respectively the DCI 1 and the DCI 4 and that are located in a cell whose cell index is 0. The two pieces of DCI come from two TRPs, and respectively correspond to a time-frequency resource set pool index 0 and a time-frequency resource set pool index 1. In addition, an assumption is that the DCI 1, the DCI 2, and the DCI 3 correspond to a same TRP.

In response to the preset rule being that the target DCI is the first piece of DCI that is obtained after all pieces of DCI in the first DCI set are first sorted based on the time dimension and the frequency domain dimension, and then all pieces of DCI in a same cell and at a same time point are sorted in ascending order of time-frequency resource set pool indexes. In response to sorting that is performed based on the time dimension and the frequency domain dimension being sorting that is performed in ascending order of time, and then cells in which DCI at each time point is located are sorted in ascending order of cell indexes, a final sorting result of the four pieces of DCI is: DCI 1, DCI 4, DCI 2, and DCI 3, and the target DCI is the DCI 1.

In response to the preset rule being that the target DCI is the last piece of DCI that is obtained after all pieces of DCI in the first DCI set are first sorted in ascending order of time-frequency resource set pool indexes, and then all pieces of DCI corresponding to each time-frequency resource set pool index are sorted based on the time dimension and the frequency domain dimension. In response to sorting that is performed based on the time dimension and the frequency domain dimension being sorting that is performed in ascending order of time, and then cells in which DCI at each time point is located are sorted in ascending order of cell indexes, a final sorting result of the four pieces of DCI is: DCI 1, DCI 2, DCI 3, and DCI 4, and the target DCI is the DCI 4.

Optionally, the target DCI is second DCI in step 501, and the second DCI indicates a location of a time domain resource of an ACK/NACK. Optionally, the second DCI belongs to the first DCI set. The second DCI is used to determine an ACK/NACK feedback resource corresponding to the first DCI set. For example, a PUCCH resource fed back by an ACK/NACK of a PDSCH corresponding to the first DCI set is determined through a PRI, and the PRI is carried in the second DCI.

Optionally, the target DCI is third DCI in step 501, and the third DCI indicates a time-frequency resource of a second feedback information set. Further, optionally, the third DCI includes the PRI, and the PRI indicates a PUCCH resource carrying the second feedback information set.

503: The terminal device determines first information based on the target DCI, where the target DCI indicates a target PDSCH, and the first information includes channel state information of the target PDSCH.

Specifically, after determining the target DCI, the terminal device obtains a time-frequency resource of the target PDSCH indicated by the target DCI, and determine the first information based on whether the target PDSCH is received on the time-frequency resource of the target PDSCH. The target PDSCH belongs to a first PDSCH set. A specific implementation of determining the first information by the terminal device is not limited herein in at least one embodiment. For a specific implementation of determining the first information, refer to content included in the first information.

Optionally, channel state information of the PDSCH includes at least one of the following: a soft-ACK, a cause of a target PDSCH decoding failure, an SNR-offset, an MCS-offset, or a target block error rate (target bier, BLER).

Soft-ACK namely, a soft information value of a result obtained by decoding of a PDSCH. The soft-ACK is different from the ACK/NACK that is fed back in the conventional technology. Generally, one PDSCH corresponds to 1-bit information, and the 1-bit information is used to carry the ACK or the NACK. However, in the soft-ACK technology, a plurality of bits, for example, 2-bit information, are used, to carry a plurality of states. For example, 00 represents the NACK; 01 represents the ACK, but there is only a low probability that 01 is decoded as the ACK; and 10 represents the ACK, but there is a medium probability that 10 is decoded as the ACK, and 11 also represents the ACK, but there is a high probability that 11 is decoded as the ACK. 01, 10, and 11 represent that data is correctly decoded, but a receiving end adjusts the SNR by using the three states. 01 represents that although data transmission receiving is correctly performed this time (decoded as the ACK), there is a low probability that the decoding is correct. In other words, although the current data is correctly decoded, there is a high probability that the decoding is incorrect. Therefore, based on 01 that is fed back, in response to scheduling data next time, a base station reduces the SNR. This ensures reliability of data transmission. 11 represents that the data is decoded correctly this time, and there is a high probability that the decoding is correct. In other words, robustness of this data transmission is very high. Therefore, in response to the base station adjusting the SNR of the scheduled data based on 11 fed back by the terminal device, the SNR is increased. This improves resource utilization for data transmission.

A cause of a PDSCH decoding failure: A cause of a downlink data transmission decoding failure this time is fed back. For example, the cause is that the MCS is too high, or is a decoding failure caused by blocking; and after receiving the information, the network device performs adjustment based on the information. For example, in response to the MCS being too high, the MCS is reduced to ensure reliability.

SNR-offset: In essence, OLLA adds a Δ_offset to an SNR determined by a CQI. Therefore, the terminal device directly feeds back the Δ_offset based on a result obtained by decoding of a PDSCH this time. In this way, the network device does not need to perform adjustment based on the ACK/NACK.

MCS-offset: The terminal device feeds back an offset relative to the MCS transmission that is performed this time. For example, an MCS index corresponding to an MCS used for data transmission that is performed this time is 5, and MCS-offset=−1 is fed back. In this case, in response to scheduling data next time, the network device uses an MCS corresponding to MCS index=4.

Target BLER: represents a target BLER corresponding to an SNR that is received by the PDSCH this time. For example, in response to the terminal device receiving downlink data that is obtained this time, SNR=20 dB is detected. An assumption is that SNR=20 dB corresponds to target BLER=10⁻⁶, the terminal device feeds back 10⁻⁶. Specific quantization is not limited in at least one embodiment. A correspondence between the SNR and the target BLER is specified by the network device, predefined in a protocol, or determined by the terminal device based on self-implementation.

Optionally, the target DCI directly indicates the target PDSCH. Alternatively, the target DCI indicates the target PDSCH by indicating the target cell. The target cell is a cell in which the target PDSCH is located.

In response to the target DCI directly indicating the target PDSCH, the target PDSCH is one or more PDSCHs in the first PDSCH set. In an implementation, the target DCI indicates a location of the target PDSCH in the first PDSCH set. The PDSCHs in the first PDSCH set are sorted according to a preset rule. The target PDSCH is an N^{th} PDSCH that is obtained after the PDSCHs in the first PDSCH set are sorted according to the preset rule. The N^{th} PDSCH is an N^{th} PDSCH in a positive order or in a reverse order.

The preset rule is a sorting rule of DCI in the first DCI set, or a sorting rule of an ACK/NACK corresponding to all PDSCHs in the first PDSCH set. This is not limited in at least one embodiment. A sorting order of the ACK/NACK corresponding to all the PDSCHs in the first PDSCH set is specified by the network device or predefined in a protocol. The PDSCHs in the first PDSCH set are sorted according to a sorting rule of the DCI in the first DCI set, which is applicable to a scenario in which each PDSCH in the first PDSCH set corresponds to one piece of DCI in the first DCI set. For sorting of the DCI in the first DCI set, refer to the description in the foregoing embodiment. Details are not described herein again.

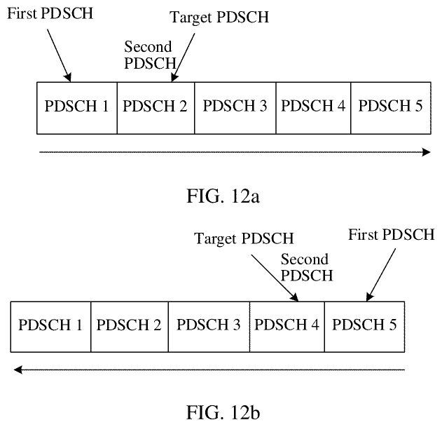

For example, an assumption is that the first PDSCH set includes five PDSCHs, and the five PDSCHs are sorted according to a preset rule: a PDSCH 1, a PDSCH 2, a PDSCH 3, a PDSCH 4, and a PDSCH 5. As shown in FIG. 12a, the target PDSCH is a second PDSCH in a positive order after five PDSCHs are sorted, to be specific, the target PDSCH is the PDSCH 2. As shown in FIG. 12b, the target PDSCH is a second PDSCH in a reverse order after five PDSCHs are sorted, to be specific, the target PDSCH is the PDSCH 4.

A beneficial effect of the N^{th} PDSCH being the N^{th} PDSCH in a reverse order is as follows: A quantity of PDSCHs corresponding to a first time unit dynamically changes, and a size of an indication field that indicates the target PDSCH in the DCI is semi-persistently configured. Therefore, a case that the quantity of PDSCHs indicated by the indication field is less than a total quantity of PDSCHs in the first PDSCH set is likely to occur. In this case, in response to the N^{th} PDSCH being in a positive order, measurement based on a last PDSCH is not indicated. However, the last PDSCH is relatively updated, and provides more timely channel state information. Measurement is performed based on the last PDSCH through the N^{th} PDSCH in a reverse order.

Optionally, the target DCI indicates that the target PDSCH is the N^{th} PDSCH in the first PDSCH set, and N is configured by a higher layer or predefined in a protocol. For example, the target DCI indicates two states. In response to the target DCI indicating a state 1, N is 1. In response to the target DCI indicating a state 2, N=5. A correspondence between the state indicated by the target DCI and N is configured by higher layer signaling.

In response to the target DCI indicating the target cell, the target PDSCH is one or more PDSCHs in the first PDSCH set that are located in the target cell. Optionally, the target PDSCH is a newly obtained PDSCH in the first PDSCH set that is located in the target cell. Alternatively, the target PDSCH is all PDSCHs in the first PDSCH set that are located in the target cell. Alternatively, the target PDSCH is indicated by the network device through indication information, and the indication information indicates whether the target PDSCH is one or more PDSCHs in the first PDSCH set that are located in the target cell.

Optionally, the target PDSCH belongs to the first PDSCH set, and the target PDSCH is one PDSCH, or includes a plurality of PDSCHs. Optionally, the target PDSCH is a PDSCH in a PDSCH corresponding to an ACK/NACK in one time unit, or the target PDSCH is not a PDSCH in a PDSCH corresponding to the ACK/NACK in one time unit. Alternatively, in response to the target PDSCH including a plurality of PDSCHs, ACKs/NACKs of some PDSCHs in the plurality of PDSCHs are located in a same time unit, and other parts are not limited.

In an implementation, the first PDSCH set further includes one or more PDSCHs determined based on the target cell.

In an implementation, the first PDSCH set is a PDSCH that is located in the target cell in PDSCHs received in a time unit within a preset time period before the first time unit. Alternatively, the first PDSCH set is a PDSCH that is located in the target cell in PDSCHs received in a time unit within a preset time period before the second time unit. The second time unit is any one of a time unit in which the PDSCH corresponding to the ACK/NACK in the first time unit is located. The first information includes the channel state information of the target PDSCH, or is expressed as: The first information includes channel state information obtained based on the target PDSCH. Alternatively, the first information includes channel state information obtained based on the first PDSCH set. Alternatively, the first information includes channel state information corresponding to the target PDSCH. Alternatively, the first information includes first CSI, and the first CSI is obtained through measurement based on downlink data carried by the target PDSCH.

Optionally, the channel state information included in the first information is further measured through other information, for example, CSI-RS information. In other words, the channel state information is obtained through joint measurement of the target PDSCH and the CSI-RS.

After obtaining the time-frequency resource of the target PDSCH based on the target DCI, the terminal device determines the first information based on whether the target PDSCH is received on the time-frequency resource of the target PDSCH.

Optionally, in response to the terminal device receiving the target PDSCH on the time-frequency resource of the target PDSCH, the terminal device determines the first information based on data information included in the target PDSCH, or determine the first information based on a demodulation reference signal (demodulation reference signal, DMRS) corresponding to the target PDSCH. The data information refers to a data packet carried on a PDSCH. The data information included in the target PDSCH includes: data information of each PDSCH in the target PDSCH, or data information of one PDSCH in the target PDSCH. The DMRS corresponding to the target PDSCH includes: a DMRS corresponding to each PDSCH in the target PDSCH, or a DMRS corresponding to one PDSCH in the target PDSCH. The PDSCH is a newly obtained PDSCH in a plurality of PDSCHs.

Optionally, in response to the terminal device receiving the target PDSCH on the time-frequency resource of the target PDSCH, the terminal device determines the first information based on a pre-coding matrix. The pre-coding matrix is obtained based on data information of one PDSCH in the target PDSCH or a DMRS corresponding to the PDSCH, or the pre-coding matrix is determined based on a CSI-RS associated with the PDSCH. In response to the target PDSCH being a plurality of PDSCHs, the PDSCH is a newly obtained PDSCH in the plurality of PDSCHs.

Optionally, the newly obtained PDSCH is a last PDSCH in time.

Optionally, in response to the terminal device not receiving the target PDSCH on the time-frequency resource of the target PDSCH, the first information includes the first state information, and the first state information indicates that the target PDSCH is not received.

Successfully receiving the target PDSCH means that DCI corresponding to the target PDSCH is successfully received and the DCI is successfully parsed. Similarly, that the target PDSCH is not received means that the DCI corresponding to the target PDSCH is not received, or the DCI corresponding to the target PDSCH is successfully received, but the DCI fails to be parsed.

504: The terminal device sends the first information to the network device, and correspondingly, the network device receives the first information from the terminal device.

Optionally, the first information and the ACK/NACK in the first time unit is jointly fed back, or the first information and the ACK/NACK is independently fed back. In response to the first information and the ACK/NACK in the first time unit being jointly fed back, the first information and the ACK/NACK in the first time unit is jointly encoded, or the first information and the ACK/NACK in the first time unit is independently encoded.

Optionally, the first information and the ACK/NACK in the first time unit is fed back on a same resource, or is fed back on different resources. In response to the first information and the ACK/NACK in the first time unit being fed back on the same resource, the first information and the ACK/NACK in the first time unit is jointly encoded, or is independently encoded. In response to the first information and the ACK/NACK in the first time unit being fed back on different resources, the first information and the ACK/NACK in the first time unit is independently encoded.

For example, in response to the first information and the ACK/NACK being fed back in two different time units, the first information and the ACK/NACK are fed back and encoded independently.

For another example, in response to the first information and the ACK/NACK being fed back on different PUCCHs in the first time unit, the first information and the ACK/NACK are fed back and encoded independently.

For another example, in response to the first information and the ACK/NACK being fed back on a same PUCCH in the first time unit, the first information and the ACK/NACK are jointly fed back. In this case, the first information and the ACK/NACK is independently encoded, or is jointly encoded.

Optionally, the terminal device sends the first information to the network device in response to determining that a value of the first information being greater than or equal to a preset threshold. Otherwise, the terminal device does not send the first information.

Optionally, a priority of the first information is indicated through DCI corresponding to the target PDSCH corresponding to the first information. The priority is used to determine transmission of the first information. For example, in response to a time-frequency resource used for transmitting the first information overlapping with a time-frequency resource used for transmitting other information (for example, transmitting other uplink control information or uplink data), transmission of the first information is determined based on the priority. For example, in response to the priority of the first information being higher than the priority of the other information, the first information is transmitted. Conversely, other information is transmitted. Overlapping of the time-frequency resources refers to overlapping of time domain resources, overlapping of frequency domain resources, or overlapping of both time domain resources and frequency domain resources. Optionally, overlapping of the time domain resources means that a time-frequency resource corresponding to the first information and a time-frequency resource corresponding to the other information have at least one same symbol. Optionally, overlapping of the frequency domain resources means that a time-frequency resource corresponding to the first information and a time-frequency resource corresponding to the other information have at least one same subcarrier. The DCI includes an indication field of the priority. Optionally, the indication field of the priority further indicates a priority of an ACK/NACK corresponding to a PDSCH scheduled by using the DCI. In this way, overheads is reduced by directly multiplexing the indication field of the priority.

Embodiments described herein provide a communication method. The terminal device determines one or more downlink transmissions based on the downlink control information, determines the channel state information based on the one or more downlink transmissions indicated by downlink control, reports the channel state information to the network device, and enables the network device to adjust, based on the channel state information reported by the terminal device, a parameter used for data transmission. Therefore, reliability of the data transmission is improved by adjusting the parameter.

Further, optionally, the communication method provided in at least one embodiment further includes: The network device sends the second information to the terminal device, and the terminal device receives the second information from the network device. The second information is used to enable the terminal device to determine the first information based on the target DCI. In other words, the terminal device enables determining of the first information only after receiving the second information. In this way, determining of the first information is more flexible, and overheads is reduced.

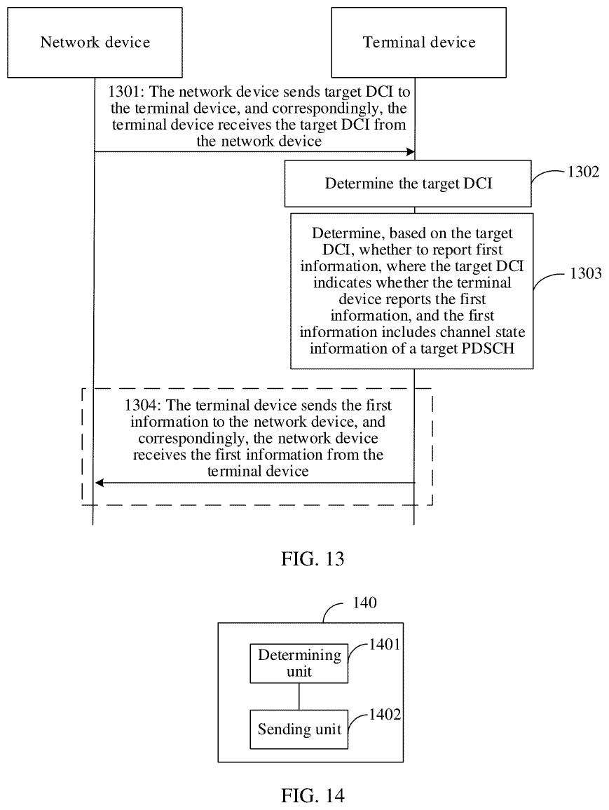

As shown in FIG. 13, the communication method provided in at least one embodiment includes the following step 1301 to step 1304.

1301: A network device sends target DCI to a terminal device, and correspondingly, the terminal device receives the target DCI from the network device.

For a detailed description of step 1301, refer to the description of step 501 in the foregoing embodiment. Details are not described herein again.

1302: The terminal device determines target DCI.

For a specific description of step 1302, refer to the description of step 502 in the foregoing embodiment. Details are not described herein again.

1303: The terminal device determines, based on the target DCI, whether to report first information, where the target DCI indicates whether the terminal device reports the first information, and the first information includes channel state information of a target PDSCH.

Specifically, In response to the terminal device determining, based on the target DCI, to report the first information, the terminal device determines the first information based on the target DCI, and perform the following step 1304. In response to the terminal device determining, based on the target DCI, not to report the first information, the terminal device stops performing the operation.

For a detailed description of determining, by the terminal device, the first information based on the target DCI, refer to the related description in step 503 in the foregoing embodiment. Details are not described herein again.

Optionally, the target DCI indicates, through a feedback indication field, whether the terminal device reports the first information. In an implementation, the target DCI includes the feedback indication field. The feedback indication field includes a first value or a second value. The first value indicates the terminal device to report the first information, and the second value indicates the terminal device not to report the first information. The first value is 0, and the second value is 1. Alternatively, the first value is 1, and the second value is 0. Alternatively, the first value and the second value has other implementations. This is not limited herein.

Optionally, in response to the feedback indication field indicating the terminal device to report the first information, the terminal device determines all cells in which the DCI in the first DCI set or the PDSCH in the first PDSCH set is located. In addition, information corresponding to each cell in all the cells is determined in a manner of determining the first information in response to the target DCI indicating the target cell in step 503. In this case, the first information includes information corresponding to all the cells. Alternatively, the terminal device determines the first information based on one or more PDSCHs in the first PDSCH set. Alternatively, the terminal device determines the first information based on one or more PDSCHs indicated by the second indication information. For example, the second indication information indicates a target cell. In this case, the first information is obtained based on a PDSCH in the target cell. For example, in response to the second indication information indicating a location of the target PDSCH, the first information is determined based on the target PDSCH. Optionally, the second indication information is higher layer signaling. Alternatively, the terminal device determines the first information based on one PDSCH. A location of the PDSCH in the first PDSCH set is preset, or the PDSCH is indicated by the network device or specified in a protocol, or the PDSCH is a newly received PDSCH in the first PDSCH set, or the PDSCH is a last scheduled PDSCH in the first PDSCH set. Alternatively, the PDSCH has another implementation. This is not limited in at least one embodiment.

Optionally, in response to the feedback indication field indicating the terminal device to report the first information, the terminal device determines the target PDSCH to determine the first information. There is one or more target PDSCHs. Optionally, in response to there being a plurality of target PDSCHs, the plurality of target PDSCHs belong to different cells.

Optionally, the target DCI indicates, through a trigger state (trigger state), whether the terminal device reports the first information. For example, the target DCI indicates one trigger state. The trigger state includes a first state or a special state. The first state is associated with a CSI-RS and/or a CSI-RS reporting configuration. The CSI-RS reporting configuration indicates a target PDSCH, or a target cell, or indication information. The indication information indicates the target PDSCH or the target cell. For a specific indication of the target PDSCH, refer to the foregoing step 503. The special state indicates that the terminal device does not report the first information.

Optionally, in response to the terminal device not receiving the target PDSCH, the first information includes first state information, and the first state information indicates that the target PDSCH is not received.

1304: The terminal device sends the first information to the network device, and correspondingly, the network device receives the first information from the terminal device.

The terminal device determines, based on the target DCI, whether to report the first information, and determines and reports the first information only in response to determining that the first information is to be reported. In response to determining that the first information is not to be reported, the terminal device does not need to determine the first information. In response to the channel state information not being reported, energy consumption of the terminal device is reduced, and determining of the first information is also more flexible.

The solutions provided in at least one embodiment are mainly described above from a perspective of a method. To implement the foregoing functions, corresponding hardware structures and/or software modules for performing the functions are included. A person skilled in the art should be easily aware that, in combination with the units and algorithm steps of the examples described in the embodiments disclosed herein is implemented by hardware or a combination of hardware and computer software. Whether a function is performed by hardware or hardware driven by computer software depends on particular applications and design constraints of the technical solutions. A person skilled in the art uses different methods to implement the described functions of at least one embodiment, but the implementation does not go beyond the scope of embodiments described herein.

FIG. 14 is a schematic diagram of a structure of a communication apparatus 140 according to at least one embodiment. The communication apparatus 140 is a terminal device, a CPU in a terminal device, a control module in a terminal device, or a client in a terminal device. The communication apparatus 140 is configured to perform the communication method shown in FIG. 5. The communication apparatus 140 includes a determining unit 1401 and a sending unit 1402.

The determining unit 1401 is configured to determine target DCI, where the target DCI indicates a target PDSCH; and determine first information based on the target DCI, where the first information includes channel state information of the target PDSCH. For example, with reference to FIG. 5, the determining unit 1401 is configured to perform step 502 and step 503. The sending unit 1402 is configured to send the first information determined by the determining unit 1401 to a network device. For example, with reference to FIG. 5, the sending unit 1402 is configured to perform step 504.

Optionally, the target PDSCH belongs to a first PDSCH set, the target DCI belongs to a first DCI set, and the first DCI set is associated with the first PDSCH set.

Optionally, the method for “the first DCI set is associated with the first PDSCH set” includes: ACK feedback information or NACK feedback information corresponding to at least two PDSCHs in the first PDSCH set is located in one time unit. The ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by DCI in the first DCI set belongs to the first PDSCH set.

Optionally, the target DCI indicates at least one of the following: the target PDSCH or a target cell, where the target cell is a cell in which the target PDSCH is located.

Optionally, the target DCI indicates the target PDSCH, and the target PDSCH is one or more PDSCHs in the first PDSCH set.

Optionally, the method for “the target DCI indicates the target PDSCH” includes: The target DCI indicates a location of the target PDSCH in the first PDSCH set, and the PDSCHs in the first PDSCH set are sorted according to a preset rule.

Optionally, the target PDSCH is an N^{th} PDSCH that is obtained after the PDSCHs in the first PDSCH set are sorted according to the preset rule, and the N^{th} PDSCH is an N^{th} PDSCH in a positive order or in a reverse order.

Optionally, the target DCI indicates the target cell, and the target PDSCH is one or more PDSCHs in the first PDSCH set that are located in the target cell.

Optionally, the determining unit 1401 is specifically configured to: determine the first information based on data information included in the target PDSCH; or determine the first information based on a DMRS corresponding to the target PDSCH.

Optionally, in response to the terminal device not receiving the target PDSCH, the first information includes first state information, and the first state information indicates that the target PDSCH is not received.

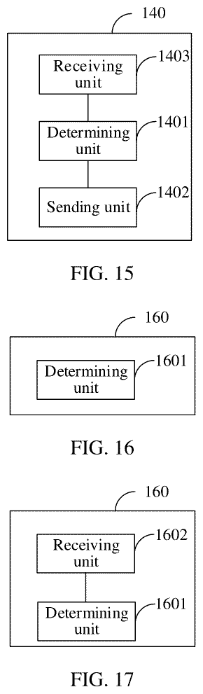

Optionally, as shown in FIG. 15, the communication apparatus 140 further includes: a receiving unit 1403. The receiving unit 1403 is configured to receive second information from the network device, where the second information is used to enable the terminal device to determine the first information based on the target DCI.

Certainly, the communication apparatus 140 provided in at least one embodiment includes but is not limited to the foregoing modules.

In actual implementation, the determining unit 1401 is implemented by a processor of the communication apparatus shown in FIG. 4. The sending unit 1402 and the receiving unit 1403 is implemented through a communication interface of the communication apparatus shown in FIG. 4. For a specific execution process, refer to the description of the communication method part shown in FIG. 5. Details are not described herein again.

FIG. 16 is a schematic diagram of a structure of another communication apparatus 160 according to at least one embodiment. The communication apparatus 160 is a terminal device, a CPU in a terminal device, a control module in a terminal device, or a client in a terminal device. The communication apparatus 160 is configured to perform the communication method shown in FIG. 13. The communication apparatus 160 includes a determining unit 1601.

The determining unit 1601 is configured to determine target DCI, and determine, based on the target DCI, whether to report first information. The target DCI indicates whether the terminal device reports the first information. The first information includes channel state information of a target PDSCH, the target PDSCH belongs to a first PDSCH set, the target DCI belongs to a first DCI set, and the first DCI set is associated with the first PDSCH set. For example, with reference to FIG. 13, the determining unit 1601 is configured to perform step 1303 and step 1304.

Optionally, the method for “the first DCI set is associated with the first PDSCH set” includes: ACK feedback information or NACK feedback information corresponding to at least two PDSCHs in the first PDSCH set is located in one time unit. The ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by DCI in the first DCI set belongs to the first PDSCH set.

Optionally, the determining unit 1601 is specifically configured to: in response to the target DCI indicating the terminal device to report the first information, determine, by the terminal device, the first information based on the target DCI. The target DCI further indicates the target PDSCH.

Optionally, the target DCI indicates at least one of the following: the target PDSCH or a target cell, where the target cell is a cell in which the target PDSCH is located.

Optionally, the target DCI indicates the target PDSCH, and the target PDSCH is one or more PDSCHs in the first PDSCH set.

Optionally, the method for “the target DCI indicates the target PDSCH” includes: The target DCI indicates a location of the target PDSCH in the first PDSCH set, and the PDSCHs in the first PDSCH set are sorted according to a preset rule.

Optionally, the target PDSCH is an N^{th} PDSCH that is obtained after the PDSCHs in the first PDSCH set are sorted according to the preset rule, and the N^{th} PDSCH is an N^{th} PDSCH in a positive order or in a reverse order.

Optionally, the target DCI indicates the target cell, and the target PDSCH is one or more PDSCHs in the first PDSCH set that are located in the target cell.

Optionally, the determining unit 1601 is specifically configured to: determine the first information based on data information included in the target PDSCH; or determine the first information based on a DMRS corresponding to the target PDSCH.

Optionally, in response to the terminal device not receiving the target PDSCH, the first information includes first state information, and the first state information indicates that the target PDSCH is not received.

Optionally, as shown in FIG. 17, the communication apparatus 160 further includes: a receiving unit 1602. The receiving unit 1602 is configured to receive second information from the network device, where the second information is used to enable the terminal device to determine the first information based on the target DCI.

Certainly, the communication apparatus 160 provided in at least one embodiment includes but is not limited to the foregoing modules.

In actual implementation, the determining unit 1601 is implemented by a processor of the communication apparatus shown in FIG. 4. The receiving unit 1602 is implemented through a communication interface of the communication apparatus shown in FIG. 4. For a specific execution process, refer to the description of the communication method part shown in FIG. 13. Details are not described herein again.

Another embodiment of at least one embodiment further provides a computer-readable storage medium. The computer-readable storage medium stores computer instructions. In response to the computer instructions running on a terminal device, the terminal device is enabled to perform steps performed by the terminal device in the method procedures shown in the foregoing method embodiments.

Another embodiment of at least one embodiment further provides a chip system, and the chip system is used in a terminal device. The chip system includes one or more interface circuits and one or more processors. The interface circuit and the processor are interconnected through a cable. The interface circuit is configured to receive a signal from a memory of the terminal device, and send the signal to the processor. The signal includes computer instructions stored in the memory. In response to the processor executing the computer instructions, the terminal device performs steps performed by the terminal device in the method procedures shown in the foregoing method embodiments.

In another embodiment of at least one embodiment, a computer program product is further provided. The computer program product includes computer instructions, and in response to the computer instructions running on a terminal device, the terminal device is enabled to perform steps performed by the terminal device in the method procedures shown in the foregoing method embodiments.

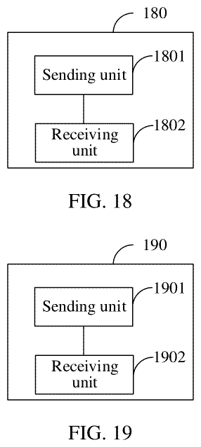

FIG. 18 is a schematic diagram of a structure of a communication apparatus 180 according to at least one embodiment. The communication apparatus 180 is a network device, a CPU in a network device, a control module in a network device, or a client in a network device. The communication apparatus 180 is configured to perform the communication method shown in FIG. 5. The communication apparatus 180 includes a sending unit 1801 and a receiving unit 1802.

The sending unit 1801 is configured to send a first DCI set to a terminal device. For example, with reference to FIG. 5, the sending unit 1801 is configured to perform step 501. The receiving unit 1802 is configured to receive first information from the terminal device. The first information is determined based on the target DCI, the target DCI is determined based on the first DCI set, the target DCI indicates the target PDSCH, and the first information includes channel state information of the target PDSCH. For example, with reference to FIG. 5, the receiving unit 1802 is configured to perform step 504.

Optionally, the sending unit 1801 is further configured to send second information to the terminal device, where the second information is used to enable the terminal device to determine the first information based on the target DCI.

Optionally, the target PDSCH belongs to a first PDSCH set, the target DCI belongs to a first DCI set, and the first DCI set is associated with the first PDSCH set.

Optionally, the method for “the first DCI set is associated with the first PDSCH set” includes: ACK feedback information or NACK feedback information corresponding to at least two PDSCHs in the first PDSCH set is located in one time unit. The ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by DCI in the first DCI set belongs to the first PDSCH set.

Optionally, the target DCI indicates at least one of the following: the target PDSCH or a target cell, where the target cell is a cell in which the target PDSCH is located.

Optionally, the target DCI indicates the target PDSCH, and the target PDSCH is one or more PDSCHs in the first PDSCH set.

Optionally, the method for “the target DCI indicates the target PDSCH” includes: The target DCI indicates a location of the target PDSCH in the first PDSCH set, and the PDSCHs in the first PDSCH set are sorted according to a preset rule.

Optionally, the target PDSCH is an N^{th} PDSCH that is obtained after the PDSCHs in the first PDSCH set are sorted according to the preset rule, and the N^{th} PDSCH is an N^{th} PDSCH in a positive order or in a reverse order.

Optionally, the target DCI indicates the target cell, and the target PDSCH is one or more PDSCHs in the first PDSCH set that are located in the target cell.

Certainly, the communication apparatus 180 provided in at least one embodiment includes but is not limited to the foregoing modules.

In actual implementation, the sending unit 1801 and the receiving unit 1802 is implemented through a communication interface of the communication apparatus shown in FIG. 4. For a specific execution process, refer to the description of the communication method part shown in FIG. 5. Details are not described herein again.

FIG. 19 is a schematic diagram of a structure of a communication apparatus 190 according to at least one embodiment. The communication apparatus 190 is a network device, a CPU in a network device, a control module in a network device, or a client in a network device. The communication apparatus 190 is configured to perform the communication method shown in FIG. 13. The communication apparatus 190 includes a sending unit 1901 and a receiving unit 1902.

The sending unit 1901 is configured to send a first DCI set to a terminal device. For example, with reference to FIG. 13, the sending unit 1901 is configured to perform step 1301. The receiving unit 1902 is configured to receive first information from the terminal device. The first information is determined based on the target DCI in response to the target DCI indicating the terminal device to report the first information, the target DCI is determined based on the first DCI set, the target DCI indicates whether the terminal device reports the first information, and the target DCI indicates the target PDSCH. The first information includes channel state information of the target PDSCH. The target PDSCH belongs to a first PDSCH set, the target DCI belongs to a first DCI set, and the first DCI set is associated with the first PDSCH set. For example, with reference to FIG. 13, the receiving unit 1902 is configured to perform step 1304.

Optionally, the method for “the first DCI set is associated with the first PDSCH set” includes: ACK feedback information or NACK feedback information corresponding to at least two PDSCHs in the first PDSCH set is located in one time unit. The ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by DCI in the first DCI set belongs to the first PDSCH set.

Optionally, the target DCI indicates at least one of the following: the target PDSCH or a target cell, where the target cell is a cell in which the target PDSCH is located.

Optionally, the target DCI indicates the target PDSCH, and the target PDSCH is one or more PDSCHs in the first PDSCH set.

Optionally, the method for “the target DCI indicates the target PDSCH” includes: The target DCI indicates a location of the target PDSCH in the first PDSCH set, and the PDSCHs in the first PDSCH set are sorted according to a preset rule.

Optionally, the target PDSCH is an N^{th} PDSCH that is obtained after the PDSCHs in the first PDSCH set are sorted according to the preset rule, and the N^{th} PDSCH is an N^{th} PDSCH in a positive order or in a reverse order.

Optionally, the target DCI indicates the target cell, and the target PDSCH is one or more PDSCHs in the first PDSCH set that are located in the target cell.

Optionally, the sending unit 1901 is further configured to send second information to the terminal device, where the second information is used to enable the terminal device to determine the first information based on the target DCI.

Certainly, the communication apparatus 190 provided in at least one embodiment includes but is not limited to the foregoing modules.

In actual implementation, the sending unit 1901 and the receiving unit 1902 is implemented through a communication interface of the communication apparatus shown in FIG. 4. For a specific execution process, refer to the description of the communication method part shown in FIG. 13. Details are not described herein again.

At least one embodiment further provides a computer-readable storage medium. The computer-readable storage medium stores computer instructions. In response to the computer instructions running on a network device, the network device is enabled to perform steps performed by the network device in the method procedures shown in the foregoing method embodiments.

At least one embodiment further provides a chip system, and the chip system is used in a network device. The chip system includes one or more interface circuits and one or more processors. The interface circuit and the processor are interconnected through a cable. The interface circuit is configured to receive a signal from a memory of the network device, and send the signal to the processor. The signal includes computer instructions stored in the memory. In response to the processor executing the computer instructions, the network device performs steps performed by the network device in the method procedures shown in the foregoing method embodiments.

In at least one embodiment, a computer program product is further provided. The computer program product includes computer instructions, and in response to the computer instructions running on a network device, the network device is enabled to perform steps performed by the network device in the method procedures shown in the foregoing method embodiments.

All or a part of the foregoing embodiments is implemented by software, hardware, firmware, or any combination thereof. In response to a software program being used to implement the embodiments, all or a part of the embodiments is implemented in a form of a computer program product. The computer program product includes one or more computer instructions. In response to the computer-executable instructions being loaded and executed on a computer, the procedure or functions according to at least one embodiment are all or partially generated. The computer is a general-purpose computer, a dedicated computer, a computer network, or another programmable apparatus. The computer instructions is stored in a computer-readable storage medium or is transmitted from a computer-readable storage medium to another computer-readable storage medium. For example, the computer instructions is transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium is any usable medium accessible by a computer, or a data storage device integrating one or more usable media, for example, a server or a data center. The usable medium is a magnetic medium (for example, a floppy disk, a hard disk, or a magnetic tape), an optical medium (for example, a DVD), a semiconductor medium (for example, a solid-state disk (solid-state disk, SSD)), or the like.

The foregoing descriptions are merely specific implementations of at least one embodiment. Any variation or replacement readily figured out by a person skilled in the art based on the specific implementations provided in embodiments described herein shall fall within the protection scope of the claims.

1. A communication method, wherein the method comprises:
determining target downlink control information (DCI) belonging to a first DCI set, indicating a target physical downlink shared channel (PDSCH) belonging to a first PDSCH set, wherein the first DCE set is associated with the first DCI set;
determining first information based on data information included in the target PDSCH; or determining the first information based on a demodulation reference signal DMRS corresponding to the target PDSCH, wherein the first information includes channel state information of the target PDSCH; and
sending the first information.

2. The communication method according to claim 1, wherein the determining the target DCI belonging to the first DCI set indicating the target PDSCH belonging to the first PDSCH set includes:
determining acknowledgment (ACK) feedback information or negative acknowledgment (NACK) feedback information corresponding to at least two PDSCHs in the first PDSCH set is located in one time unit, wherein the ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by using DCI in the first DCI set belongs to the first PDSCH set.

3. The communication method according to claim 1, wherein the determining the target DCI belonging to the first DCI set indicating the target PDSCH includes:
determining PDSCHs in the first PDSCH set are sorted according to a preset rule, wherein the target DCI indicates a location of the target PDSCH in the first PDSCH set.

4. The communication method according to claim 1, wherein the determining the target DCI further includes indicating the target cell, wherein the target PDSCH is one or more PDSCHs in the first PDSCH set that are located in the target cell.

5. The communication method according to claim 1, wherein the communication method further comprises:
receiving second information from the network device, wherein the second information is used to enable the terminal device to determine the first information based on the target DCI.

6. A communication method, wherein the method comprises:
sending target DCI belonging to a first DCI set, indicating a target PDSCH belonging to a first PDSCH set, wherein the first DCI set is associated with the first PDSCH set; and
receiving first information, wherein the first information comprises includes channel state information of the target PDSCH.

7. The communication method according to claim 6, wherein that the sending the target DCI belonging to the first DCI set is-indicating a target PDSCH associated with the first PDSCH set includes:
sending ACK feedback information or negative acknowledgment NACK feedback information corresponding to at least two PDSCHs in the first PDSCH set located in one time unit, wherein the ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by using DCI in the first DCI set belongs to the first PDSCH set.

8. The communication method according to claim 6, wherein the sending the target DCI indicating the target PDSCH includes:
sending PDSCHs in the first PDSCH set sorted according to a preset rule, wherein the target DCI indicates a location of the target PDSCH in the first PDSCH set.

9. The communication method according to claim 6, wherein the sending the target DCI includes sending the target DCI indicating a target cell, and the target PDSCH is one or more PDSCHs in the first PDSCH set that are located in the target cell.

10. The communication method according to claim 6, wherein the communication method further comprises:
sending second information, wherein the second information is used to enable the terminal device to determine the first information based on the target DCI.

11. A communication apparatus, comprising:
memory storing a program; and
one or more processors, coupled to the memory, wherein the one or more processors are configured to execute the program to perform:
determining DCI, wherein the target DCI indicates a target PDSCH;
determining first information based on data information included in the target PDSCH; or determining the first information based on a demodulation reference signal DMRS corresponding to the target PDSCH, wherein the first information includes channel state information of the target PDSCH; and
sending the first information;
wherein the target PDSCH belongs to a first PDSCH set, the target DCI belongs to a first DCI set, and the first DCI set is associated with the first PDSCH set.

12. The communication apparatus according to claim 11, wherein the first DCI set is-associated with the first PDSCH set includes:
acknowledgment (ACK) feedback information or negative acknowledgment (NACK) feedback information corresponding to at least two PDSCHs in the first PDSCH set is located in one time unit, wherein the ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by using DCI in the first DCI set belongs to the first PDSCH set.

13. The communication apparatus according to claim 11, wherein the target PDSCH includes:
PDSCHs in the first PDSCH set sorted according to a preset rule, wherein the target DCI indicates a location of the target PDSCH in the first PDSCH set.

14. The communication apparatus according to claim 11, wherein the target DCI further indicates the target cell, and the target PDSCH is one or more PDSCHs in the first PDSCH set that are located in the target cell.

15. The communication apparatus according to claim 11, wherein the one or more processors are further configured to perform:
receiving second information from the network device, wherein the second information is used to enable the terminal device to determine the first information based on the target DCI.

16. A communication apparatus, comprising:
memory storing a program; and
one or more processors, coupled to the memory, wherein the one or more processors are configured to execute the program to cause the processor to perform:
sending target DCI, wherein the target DCI indicates a target PDSCH; and
receiving first information, wherein the first information includes channel state information of the target PDSCH;
wherein the target PDSCH belongs to a first PDSCH set, the target DCI belongs to a first DCI set, and the first DCI set is associated with the first PDSCH set.

17. The communication apparatus according to claim 16, wherein that the first DCI set associated with the first PDSCH set includes:
ACK feedback information or negative acknowledgment NACK feedback information corresponding to at least two PDSCHs in the first PDSCH set is located in one time unit, wherein the ACK feedback information indicates that decoding of a corresponding PDSCH succeeds, and the NACK feedback information indicates that decoding of a corresponding PDSCH fails; and DCI for scheduling a PDSCH in the first PDSCH set belongs to the first DCI set, or a PDSCH scheduled by using DCI in the first DCI set belongs to the first PDSCH set.

18. The communication apparatus according to claim 16, wherein that the target PDSCH includes:
PDSCHs in the first PDSCH set are sorted according to a preset rule, wherein the target DCI indicates a location of the target PDSCH in the first PDSCH set.

19. The communication apparatus according to claim 16, wherein the target DCI indicates the target cell, and the target PDSCH is one or more PDSCHs in the first PDSCH set that are located in the target cell.

20. The communication apparatus according to claim 16, wherein the one or more processors are further configured to perform:
sending second information, wherein the second information is used to enable the terminal device to determine the first information based on the target DCI.
